(19) United States
(12) Patent Application Publication
(10) Pub. No.: US 2006/0123483 A1
(43) Pub. Date: Jun. 8, 2006

(54) Method and system for protecting against illegal copy and/or use of digital contents stored on optical or other media

(76) Inventor: Eyal Cohen, Kiryat Bialik (IL)

Correspondence Address: Mark Friedman;Bill Polkinghorn, 9003 Florin Way, Upper Marlboro, MD, 20772, US

(21) Appl. No.: 10/543,332

(22) PCT Filed: Feb. 4, 2004
(86) PCT No.: PCT/IL04/00120

§ 371 Date: Jul. 25, 2005

(30) Foreign Application Priority Data
Feb. 6, 2003 (IL) 154346

(51) Int. Cl. H04N 7/16; G06F 17/30; H04L 9/32; G06F 7/04; G06K 9/00; H03M 1/68; H04K 1/00; H04L 9/00

(52) U.S. Cl. 726/26; 726/29; 726/33

(57) ABSTRACT

A method for preventing the illegal copying of a copy protected content by a computerized system by installing a driver in the operating system of the computerized system for intercepting any attempt of the I/O routines of the operating system to access the device drivers of the Operating System, producing a CRC codes for data read from devices containing original copies, producing a CRC codes for data to be written to devices, and preventing any attempt to write such data whenever the CRC code produced match a CRC code produced for read data. The protection of content stored on a recordable CD can be achieved by recording on the CD a first sA method for preventing the illegal copying of a copy protected content by a computerized system by installing a driver in the operating system of the computerized system for intercepting any attempt of the I/O routines of the operating system to access the device drivers of the Operating System, producing a CRC codes for data read from devices containing original copies, producing a CRC codes for data to be written to devices, and preventing any attempt to write such data whenever the CRC code produced match a CRC code produced for read data. The protection of content stored on a recordable CD can be achieved by recording on the CD a first session including one or more Tracks, each of which includes unique and/or nonstandard data structures. The protected content is then recorded on the CD in a concealed form together with an authentication module capable of determining the existence or non-existence of the unique and/or nonstandard data structures and capable of accessing the concealed content and reveal its content. Whenever attempting to access the CD, the authentication module is activated, and if the unique and/or nonstandard data structures are found on the CD, the concealed content is revealed and accessed.

### FIELD OF THE INVENTION

The present invention relates to the field of authentication and protection of digital content from illegal copying and use. More particularly, the invention relates to a method and system for protecting digital content stored on recordable media from illegal copying and use.

### BACKGROUND OF THE INVENTION

Optical media such as CD-ROM and DVD have become major means for software storing due to the high density and reliable storage which they provide at a relatively low price. In the past, the piracy in the copying of optical media like CD-ROM was negligible, as recording machines were available only to professionals due to their high price. In recent years, the price of recording machines capable of making a perfect copy of original, prerecorded CDs and DVDs has been reduced. Consequently, the rate of illegal copying and illegal use of software has significantly increased, which resulted in significant damages to the content owners.

Compact Disks (CD) are an optical storage media of digital information (content) widely utilized for storage of audio, video, text, and other types of digital content. Their reliability, efficiency and low price made their use very common for storage of music, movies, computer software and data. The content stored on the CD may be easily copied, and actually, it is accessible utilizing the basic tools of virtually any computer Operating System (OS). The arrival of recordable CDs (CD-R), made the pirate reproduction of CDs a very simple task.

In recent years, several copy protection technologies for optical discs were developed to fight against the increasing piracy levels. Most of them are based on deliberately corrupting the disc, or changing its optical properties. The corruption of the disc is done by professional mastering equipment that is used in optical discs replication facilities. The standard optical disc recorders, that are used by pirates to make illegal copies, are not designed to corrupt the optical discs, and therefore, cannot create an exact copy of the original protected disc. A software module that is added to the optical disc, reads the areas on the disc that should be corrupted, determines if the disc is original or a copy and grant or deny access to the content on the disc accordingly.

The existing copy protection technologies may be suitable for protecting against the copying of applications such as computer games that can be replicated many times using one corrupted master that had been produced by replication facilities. The drawback of copy protection technologies that are based on intentionally corrupting the optical disc, is that they cannot be easily applied to recordable discs, since standard optical disc recorders are not designed to record information on corrupted recordable discs.

Copy protection solutions for recordable optical discs is extremely important for pre-releases (Alphas, Betas, etc.) of computer games and software. Content owners are used to publish pre-releases of their content in a limited number of copies, in order to have a field test of their software, which are important for reporting if there are any major bugs that should be fixed before releasing the final version of their product. Many times the pre-released copies, of copy right protected digital content, are copied illegally and distributed over the internet, even before the final version of the product is released to the market. The piracy of software in such an early stage, cause huge loss of sales because it damage the first wave of sales, which is the most significant. Pre-releases are published on a very limited number of copies. Usually few singles to a few hundreds, and this is the reason why in most cases they are published on recordable discs that are duplicated in-house by the content owner.

The ability to protect the content of optical recordable discs against unauthorized copying is also extremely important for publishing final versions of software in low volumes. For example, professional software that is sold in a high price for a limited professional market. In particular, a copy protection for optical recordable discs can be well exploited for on-demand environments, where a customer makes his own selection of the content he wish to buy, and a disc containing all his selections is compiled and recorded instantly.

The ability to protect the content on optical recordable discs against unauthorized copying is also extremely important for protecting confidential information in governmental institutes, military and even financial information in banks.

In addition, such a copy protection for optical recordable discs against illegal copying can also allow private consumers to record their own copy protected content, on optical discs one at a time, whenever it is needed, without needing the mass production processes carried out today by the common mastering facilities.

The ability to protect the content of optical recordable discs against unauthorized copying allows certain features that strengthen the copy protection solution, and cannot be applied easily to replicated discs. For example, the ability to make each disc unique by adding unique serial numbers, and adding unique tracking information that can help to track the original owners of original discs, from which illegal copies were made. These features will be explained in details herein later.

All the prior art solutions for protecting the content of optical storage media such as CDs DVDs have not yet provided methods and/or means for protecting recordable optical discs from copying. Therefore, methods for protecting the content on recordable discs are highly required to provide means for protecting the content produced by individuals and/or which is made available in a limited number of copies, without needing mass production mastering processes.

It is an object of the present invention to provide a method and system for protecting digital content that is recorded on standard recordable discs against unauthorized copying.

It is another object of the present invention to provide a method and system for protecting digital content from unauthorized copying, using a recordable disc that contains pre-burned information with intentionally embedded logical symbols and serial numbers, that are used for the copy protection process and for determining the authenticity of the disc and the copy protected digital content that is stored on it.

It is also an object of the present invention to provide a method for tracking the owner of an originally recorded medium, from which a pirated copy of protected digital content was made, based on a unique serial number that is recorded on both the original and the pirated copies,

It is another object of the present invention to provide a software driver that provides the operating systems of a computer the ability to transparently read digital content, that is stored in encrypted form on any medium, as long as the medium is a legitimate original. The driver also designed to block any copying attempt of the encrypted content.

Other objects and advantages of the invention will become apparent as the description proceeds.

### SUMMARY OF THE INVENTION

The terms CD-R and CD-RW are used herein to refer to CDs on which digital content can be written by end users. The term disc is used herein to refer CD-Rs and CD-RWs.

The term Cyclic Redundancy Check (CRC) refers to a method for producing a unique signature for data which is often used to detect errors in transmitted data.

The present invention is directed to a method and system for preventing the illegal copying of a copy protected content by a computerized system. The invention may comprise installing a software driver in the operating system of the computerized system, where the software module is capable of intercepting any attempt of the I/O routines of the operating system to access the device drivers of the operating system. Whenever an attempt to read data from the device drivers is intercepted the following steps are performed:
an authentication test is performed to determine if the accessed device contain an original copy, and if it is determined that the accessed device contain an illegal copy terminating the requested I/O operation;
if it is determined that the accessed device contains an original copy allowing access to the device and calculating and storing in the memory of the computerized system the CRC codes of the data read from the device;

Whenever an attempt to write data to the device drivers is intercepted performing the following steps:
calculating CRC code of the data to be written to the device;
if the calculated CRC code equals to one of the CRC codes that were previously stored in the memory of the computerized system terminating the write data attempt; and
if the calculated CRC code does not equal to any one of the CRC codes that were previously stored in the memory of the computerized system allowing the write data to be performed.

The data stored on the I/O devices may be stored in an encrypted form and the invention may therefore further comprise decrypting the encrypted data whenever it is determined that the accessed device contains an original copy. Optionally, the decryption keys may be obtained from the I/O device from which the encrypted data was read.

The invention is also directed to a method and system for protecting content stored on a recordable CD. The values of the disc ID and the Lead-in start time of the recordable CD are used for generating an encryption key which is utilized for encrypting the content that should be stored on the CD using. The encrypted content is written to the recordable CD, and whenever an attempt to read the content of the CD the following steps are performed:
the values of the disc ID and the Lead-in start time are read from the CD;
a decryption key is generated from the read values; and
the content of the CD is decrypted with the generated decryption key.

Optionally, the same key is used for carrying out the encryption and the decryption of the protected content.

The illegal copying of a copy protected content by a computerized system may be also prevented by setting a flag to a logical ON state whenever an active process attempts to read data from the content, where the flag is generally in a logical OFF state and it is associated with the process, and checking the status of the flag associated with a process attempting to output data and preventing the data output if the flag is in the logical ON state.

The present invention is also directed to a method and system for protecting the content stored on a recordable CD which comprise a pre-burned first session including one or more Tracks, each of which includes unique and/or nonstandard data structures. The protected content is recorded on the CD in a concealed form together with an authentication module capable of determining the existence or non-existence of the unique and/or nonstandard data structures and capable of accessing the concealed content and reveal its content. The authentication module is activated whenever attempting to access the CD, and if the unique and/or nonstandard data structures are found on the CD then the access to the concealed content is allowed.

The unique and/or nonstandard data structures may comprise Rom Sync Shifts, Digital Silence, Link Blocks, and/or Predetermined Rom Skew values. The recordable CD may further comprise unique serial numbers stored in predetermined locations within the one or more Tracks. The unique serial numbers may include one or more unique copy-seal serial numbers, which are stored in predetermined locations in the User Data of predetermined data frames within the Tracks, and one or more unique copy-authentication serial numbers which are stored in predetermined locations in the Sub Channels of predetermined data frames within the Tracks.

The copy-seal and/or copy-authentication serial numbers may be used to identify the original copy of the protected content which was used for the copying of a pirate copy. In a preferred embodiment of the invention a unique copy-seal and copy-authentication serial numbers are used for each and every recordable CD, and the bits of the copy-authentication serial numbers are stored in the Copy Permit/Prohibit bit of the Q Sub-Channel of a sequence of predetermined data frames within the one or more Tracks.

According to another preferred embodiment of the invention copy protected storage mediums are produced by: writing data into a first set of a predetermined number of consecutive sectors having consecutive addresses; following the first set writing different data into a second set of the same predetermined number of consecutive sectors having the same consecutive addresses as the first set, such that any attempt to copy the medium results in copying only one of the sets.

Optionally, the copy protected storage mediums are produced by: designating a sector address as a starting location for writing authenticating data sectors; following the starting location writing data into a first set of a predetermined number of consecutive sectors having consecutive addresses; following the first set, writing different data into a second set of the same predetermined number of consecutive sectors having the same consecutive addresses as the first set; and following the second set, designating a sector as an ending location and setting the address of the sector to the consecutive address following the first set, such that any attempt to copy the medium results in copying the starting location sector, one of the sets, and the ending location sector.

The authenticating of the copy protected storage mediums can be carried out by: reading the data of the first set of sectors and producing an identifier for each read sector; reading the ending location sector; reading the sectors preceding the ending location sector in a descending order, producing an identifier for each read sector, and comparing the identifier to the identifier previously produced for the corresponding sector in the first set; indicating that the storage medium is original whenever it is determined that the identifiers which were produced for corresponding sectors mismatch, and if it is determined that the identifiers match indicating the medium being a copy.

The invention is also directed to a copy protected recordable CD. The copy protected recordable CD comprises:
a) a pre-burned session comprising one or more Tracks;
b) unique and/or nonstandard data structures in the User Data field and/or the Sub Channels of predetermined frames within the Track, where only portion of the data structures can be copied by conventional recorders; and
c) one or more additional sessions comprising content encrypted by an encryption key which is generated from values obtained from the data structures; and
d) a software module capable of identifying the existence or non-existence of the data structures in the first session of a CD and determining if the CD is an original or a copy, whenever an original CD determination is obtained the software module generates a decryption key from values obtained from the data structures and decrypts the content of the additional sessions.

According to a preferred embodiment of the invention the one or more Tracks are recorded in different Subcode Formats. Optionally, the unique and/or nonstandard data structures may comprise Rom Sync Shifts, Digital Silence, Link Blocks, and/or Predetermined Rom Skew values. The copy protected recordable CD may further comprise unique serial numbers stored in predetermined locations within the one or more Tracks, where said serial numbers includes:
one or more unique copy-seal serial numbers, which are stored in predetermined locations in the User Data of predetermined data frames within the Tracks; and
one or more unique copy-authentication serial numbers which are stored in predetermined locations in the Sub Channels of predetermined data frames within the Tracks.

According to another preferred embodiment of the invention the copy-seal and/or copy-authentication serial numbers are used to identify the original copy of the protected content which was used for the copying of a pirate copy. According to yet another preferred embodiment of the invention the unique copy-seal and copy-authentication serial numbers are used for each and every recordable CD. The bits of the copy-authentication serial numbers may be stored in the Copy Permit/Prohibit bit of the Q Sub-Channel of a sequence of predetermined data frames within the one or more Tracks.

According to another preferred embodiment of the invention the copy protected recordable CD comprises a pre-burned session comprising one or more Tracks including predetermined locations within the one or more Tracks which comprise one or more unique copy-seal serial numbers, which are stored in predetermined locations in the User Data of predetermined data frames within the Tracks, and one or more unique copy-authentication serial numbers which are stored in predetermined locations in the Sub Channels of predetermined data frames within the Tracks.

### BRIEF DESCRIPTION OF THE DRAWINGS

In the drawings:

FIG. 1 schematically illustrates the data structure of CD frames;

FIG. 2 schematically illustrates structure of CD sessions and tracks;

FIG. 3 schematically illustrates the Multi-Session Layout;

FIG. 4 schematically illustrates the data structure of the Q Sub-Channel;

FIG. 5 shows the structure of recordable CDs;

FIG. 6 shows the structure of the Link Blocks;

FIG. 7 shows the Sony and the Phillips Subcode Formats;

FIG. 8A is a block diagram illustrating the data flow in a computer operating system in which the content protection driver of the invention is installed;

FIG. 8B is a flowchart illustrating the installation process of the content protection driver of the invention;

FIGS. 8C and 8D are flowcharts illustrating the operations preformed by the content protection driver of the invention;

FIG. 9 is a flowchart illustrating a method for determining if a CD is an original utilizing unique Identification Marks that exist on any recordable disc;

FIGS. 10A and 10B are flowcharts illustrating a method for determining if a CD is an original by checking the existence and format of intentionally embedded logical symbols

FIG. 11A is a flowchart illustrating a method for protecting digital content from illegal copying by means of encryption, utilizing a recordable disc with pre-burned information according to the present invention;

FIG. 11B is a flowchart illustrating a method for decrypting protected digital content that is stored on a recordable disc with pre-burned information according to the present invention;

FIG. 12A is a flowchart illustrating a method for protecting digital content on a standard recordable disc, from illegal copy and use, by means of encryption;

FIG. 12B is a flowchart illustrating a method for decrypting protected digital content that is stored on a standard recordable disc, and was protected using the process illustrated in FIG. 12a

FIG. 13A schematically illustrates the layout of a recordable disc, which includes pre-burned information containing intentionally embedded logical symbols and serial numbers;

FIG. 13B schematically illustrates the structure of the pre-burned information that is recorded on the disc illustrated using FIG. 13a;

FIG. 14 is a flowchart illustrating a method for tracking content management and protecting digital content from illegal copy and use by means of encryption, using recordable discs with unique serial numbers;

FIG. 15 is a flowchart illustrating a method for tracking pirates that make illegal copies of digital content that is stored on recordable discs with unique serial numbers;

FIG. 16 schematically illustrates the use of the present invention by any content owner that wish to protect its content from illegal copying;

FIG. 17 is a block diagram illustrating the structure of a Virtual Digital Hologram in a preferred embodiment of the invention; and

FIG. 18 is a flow chart illustrating a process for authenticating storage media utilizing the Virtual Digital Hologram of the invention.

### DETAILED DESCRIPTION OF PREFERRED EMBODIMENTS

Copy protection for software is usually implemented by integrating an authentication procedure into the software, that checks if the medium that the software is stored on is original. The execution of the protected software is carried out whenever it is determined that the storage medium that is being used is original, and it is terminated whenever it is not so.

The copy protection of digital content other than software (e.g., text, music) cannot be protected using such techniques, since the access to such content usually does not involve initiating any process originated from the storing media, and therefore it is accessed in the same manner whether the storing medium is original or not. The present invention provides an architecture for a software driver (hereinafter will be also referred to as content protection driver), that is installed in the operating system and adds support for reading encrypted content from any medium as long as it is original. The process of decrypting the content is fully transparent to the end user. The media may contain any type of content such as MPEG video files or MP3 audio files. This content may be used in a normal way, for example by playing the video and audio files with any player that may be installed on the users computer. However, any copying attempt of the content will be blocked by the content protection driver.

The content is preferably stored on the protected media in an encrypted form. The protection of the stored content is carried out by the content protection driver, that intercepts any reading and/or writing operations initiated from the user's computer. When the storing media, on which the encrypted content is stored, is accessed, the content protection driver verifies that the media is original by using one or more of the authentication methods that are described herein. If the storing media is indeed original, the content protection driver decrypts the information that is read from the media, and calculate a Cyclic Redundancy Check (CRC) code for that read operation. The content protection driver stores in the computer's memory the calculated CRC codes of several read operations that have been performed recently. When the content protection driver intercept a write operation, it calculates the CRC code for the information that should be written. If the CRC code that was calculated for the information to be written matches one of the last CRC codes of the read operations that are stored in the computer memory, the content protection driver blocks the write operation, or writes faked content instead (e.g., random data).

This unique method solves the problems of many existing content protection/encryption methods, wherein it is impossible to use a fully transparent system for decrypting the encrypted content and allow any program to use it. Most of the content protection methods which are based on storing encrypted content requires the user to enter some code or use an external device that holds the decryption keys which enables accessing the encrypted content. The main problem in a fully transparent system is that any active process capable of accessing the OS resources can also gain access to the encrypted content, and therefore any copying software is also capable of doing the same i.e., reading and copying the protected content. For example, a fully transparent system will allow the windows explorer of a MS-Windows operating system to read the encrypted content that can then be written to a different medium.

Copy protection system usually includes an authentication process that is used for determining if the storing medium that is used is original or not. Based on the result of this authentication process the access to the protected content is granted or denied. The present invention provides two different methods for determining if the medium is original or not. The methods that will be described hereinafter were particularly adapted for optical recordable discs.

The authentication process of the first method is preformed to standard recordable discs, utilizing unique Identification Marks that exist on any recordable disc.

The authentication process of the second method is mainly based on the fact that two different discs that contains the same content, but were recorded using different recorders, and maybe even different recording methods, essentially have some minor differences between them. The authentication method of the present invention, exploit said differences to determine if the disc that is used is original, or a copy made by a different recorder and maybe even by using a different recording method.

The authentication process of the second method is performed to standard recordable discs that have a pre-burned area which includes intentionally embedded logical symbols and unique serial numbers. The authentication process is designed to read information from the pre-burned area and use it to determine if the disc is original or not. As will be explained, the serial numbers that are embedded into the discs, are unique for each and every disc, although the same information maybe recorded on the discs. Should an illegal copy be found, the serial numbers may also be used to identify the owner of the original disc, from which the copy was made.

As will be understood by those skilled in the art, the authentication methods of the present invention, can be integrated into processes of almost any software. While the software run, the authentication processes are carried out to determine if the medium on which it is stored is an original medium or not, and its operation is continued or terminated accordingly. Additionally, these authentication methods can also be integrated into the authentication procedures of the content protection driver of the present invention, in order to provide a copy protection mechanism which is also suitable for any type of digital content other than software, by utilizing encryption means.

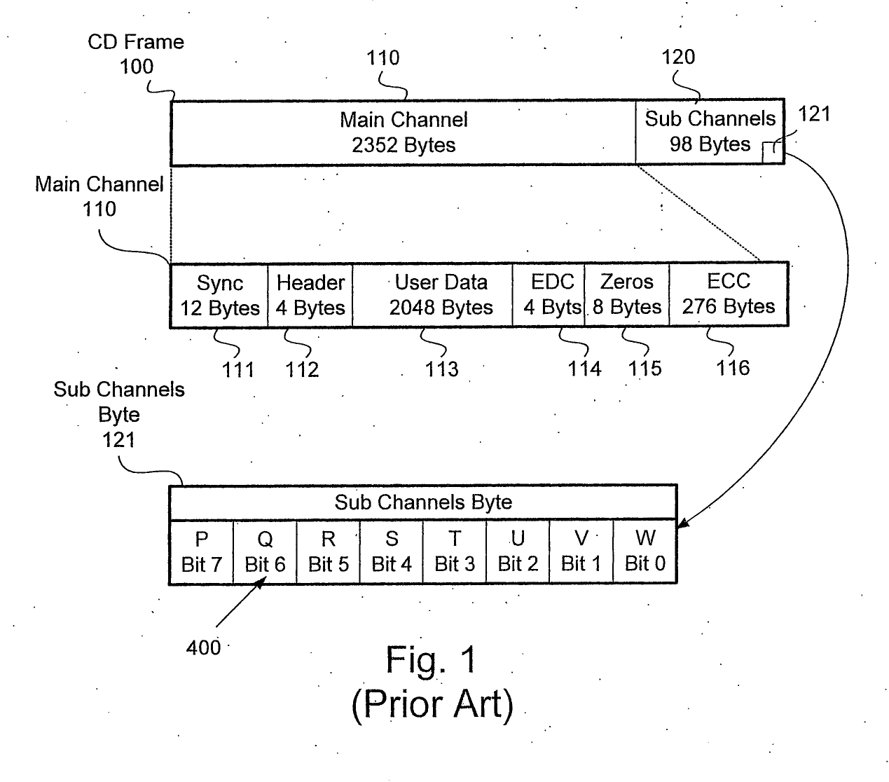

A typical recorded CD media consists from a succession of CD frames. FIG. 1 schematically illustrates the structure of a CD frame 100. Each CD frame 100 comprises a Main Channel 110 consisting of 2352 bytes, and of a 98 bytes of sub channel data 120. CD frames are addressed in terms of audio play time, i.e. Minutes, Seconds, and Frames (MSF). The traditional value of 60 seconds per minute is followed.

The structure of the main channel block 110 is determined by the type of information that is recorded on the CD. Audio, computer data and video content have different main channel block structures. The main channel block 110 shown in FIG. 1 is a mode 1 data block, that is used for computer data, as defined in the Phillips' Yellow Book standard. The sync field 111, contains 12 bytes which holds a synchronization pattern. The Header field 112, contains 3 bytes value that represents the address (also known as absolute time ATIME) of the current CD frame in MSF format, and 1 byte value that represents the main channel block mode, which is mode 1 in this case. The EDC field 114, is a 4 bytes CIRC (Cross-Interleaved Reed-Solomon Code) codeword that is used for error detection and is calculated using the information stored on the Sync 111, Header 112 and user data 113 fields. Field 115 consists of 8 bytes that are reserved and set to zero. The ECC field 116 consists of 276 bytes that are used for error correction of corrupted information in the Sync 111, Header 112, and User Data 113 fields. These fields (111, 112, 114, 115 and 116) are also known as control fields, and they consume 288 bytes, which leaves a total of 2048 bytes for the user data in the user data field 113.

The synchronization pattern of the main channel of a disc (Sync 111) typically occurs every 2352 bytes (at the beginning of each CD frame). However, the distance between two consecutive synchronization patterns may be less or greater than 2352 bytes. This phenomenon is known as Rom Sync Shift and it usually appears due to errors in the manufacturing process of CD-ROM masters. Recording devices are typically not designed to create Rom Sync Shifts. According to the present invention, intentionally embedded Rom Sync Shifts are utilized to authenticate a copy protected recordable disc, as will be shown and explained herein later.

The Sub Channels field 120, consists of 2 synchronization bytes and 96 bytes of Sub Channels information. Each Sub-Channels information byte 121 is divided into 8 Sub-Channel bits labeled using the letters P to W according to their bit position, as shown in FIG. 1. Each Sub-Channel consists of 12 bytes per CD frame (96 bits). The P and Q sub-Channels provide information about the recording. The R-W Sub-Channels are defined only for audio CD frames.

All the information in the frame's main channel 110, except to the Sync field 111, is scrambled. The scrambling is preformed by XORing the information of the main channel 110 with predetermined values. When information is read from the disc, the reading device automatically unscramble the information before sending it to the reading application. A sequence of one or more CD frames that contains zeros on all fields after scrambling is called “digital silence”. Standard discs typically do not contain digital silences. As will be explained herein later, these “digital silence” frames can be used to authenticate a copy protected recordable discs according to the method of the invention.

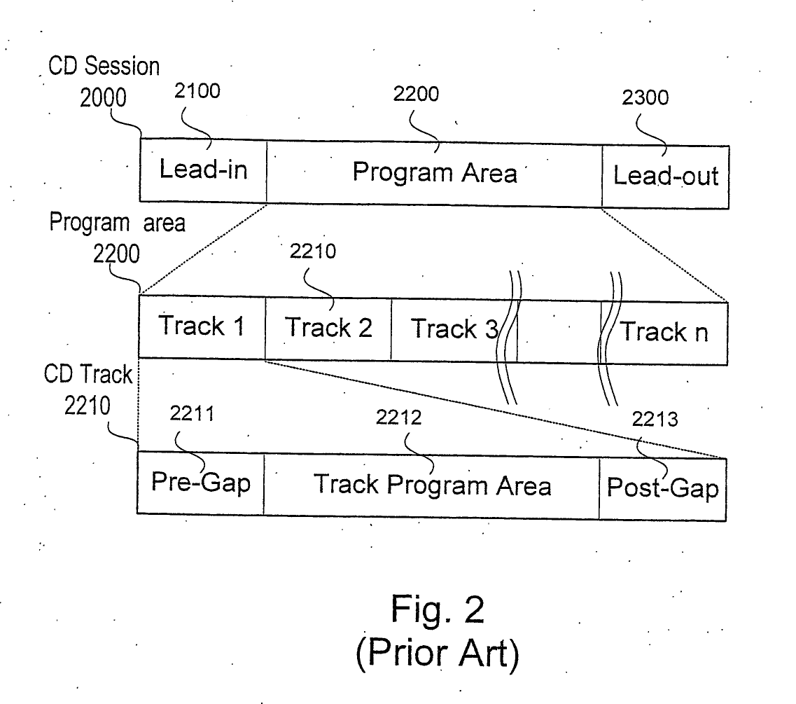

The information on a disc is recorded in a logical structure called session. A session is divided into 3 logical entities beginning from the inner radius of the disc and continuing toward its outer edge. FIG. 2 schematically illustrates the structure of a CD session 2000. The Lead-in, field 2100, is a zone of protection for preventing readings from unrecorded areas near the disc center, it signals the drive the beginning of the recorded area. The Lead-in 2100 also contains the Table of Contents (TOC) for the Program Area 2200. The Program Area field 2200 is also known as the user area of the disc. For example, on an audio CD, this is where the music is recorded. The Lead-out field 2300 is a zone of protection for preventing readings from unrecorded areas toward the disc's outer edge, it signals the drive the ending of the recorded area.

The Program Area 2200 is divided into logically separated areas called tracks 2210. There should be at least 1 track 2210 in the Program Area 2200. Each track 2210 contains 2 pause areas. The Pre-Gap, field 2211, and the Post-Gap, field 2213. The length of each of said pause areas is 150 CD frames. The P Sub-Channel is reserved for identifying the gaps. The value of the P Sub-Channel in the Program Area is 0 its value is set to 1 in the Gaps areas 2211 and 2213. The data frames within the Program Area, field 2212, are used for storing the user content e.g., computer files.

When writing to a standard recordable disc, using a standard recording device, the Pre-Gap area 2211 of each track is filled with CD frames that contain zeros (frames in which all the bytes of the User Data 113 holds zero values) or Track Descriptors, depending on the recorder that is used. Track Descriptors are used to describe the track in which they are written and they contain information such as the length of the track and the recording method that is used to record the track. The Track Descriptors have no affect on the functionality of the disc, and as mentioned above some recorders may even write in the Pre-Gap area 2211 CD frames that contain zeros in the User Data field 113 instead of Track Descriptors.

A session is constructed from the following recorded sequence: Lead-in 2100, Tracks Area 2200, and Lead-out 2300. However, there is also a multi-session technique which allows a single disc to have several concatenated sessions. As will be discussed hereinafter this mode can be exploited for the construction of a copy protection scheme for recordable optical discs

The first frame of a blank recordable disc starts at a negative address which its value depends on the disc manufacturer. This start address is also known as the “Lead-in Start Time”. A negative address in MSF addressing is defined as a count down from address 00:00:00, for example, the address −1 is represented as 99:59:74. The Program Area 2200, always starts at address 00:00:00 (MSF). Therefore, the length of the first Lead-in is varying in different disc brands. The time lengths of the subsequent Lead-ins (e.g., session No. 2 and above) are typically 60 seconds long. A blank recordable disc also has a unique 32 bits number that is recorded on it. This number is called the Disc ID. The Disc ID and the Lead-in Start Time can be read by using the standard Multi Media command ‘Read Disc Information’ as defined in the SCSI MMC-3 standard (NCITS. 360:2002.)

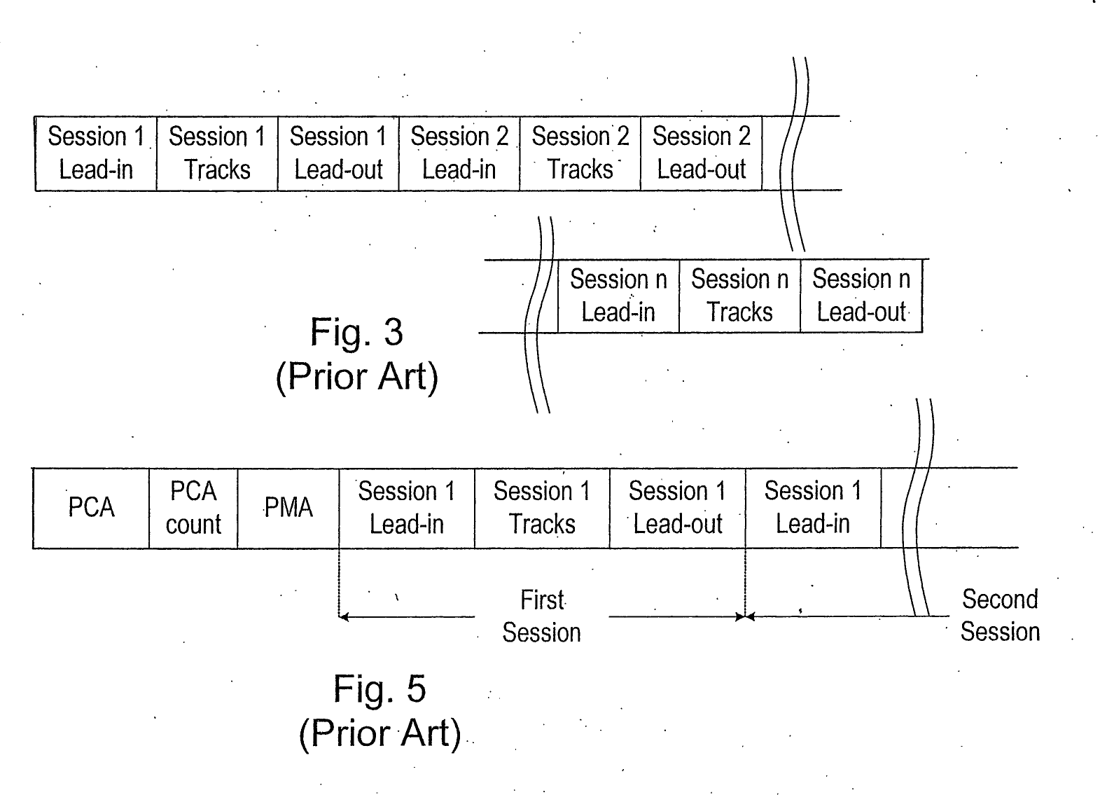

Typical CD-ROM devices are not capable of reading through unrecorded areas on the medium. This means that to ensure that a CD-ROM device is capable of accessing all areas of the Program Area 2200, the Program Area 2200 needs the Lead-in 2100 and Lead-out 2300, protection zones. On a recorded disc, sessions may appear as shown in FIG. 3.

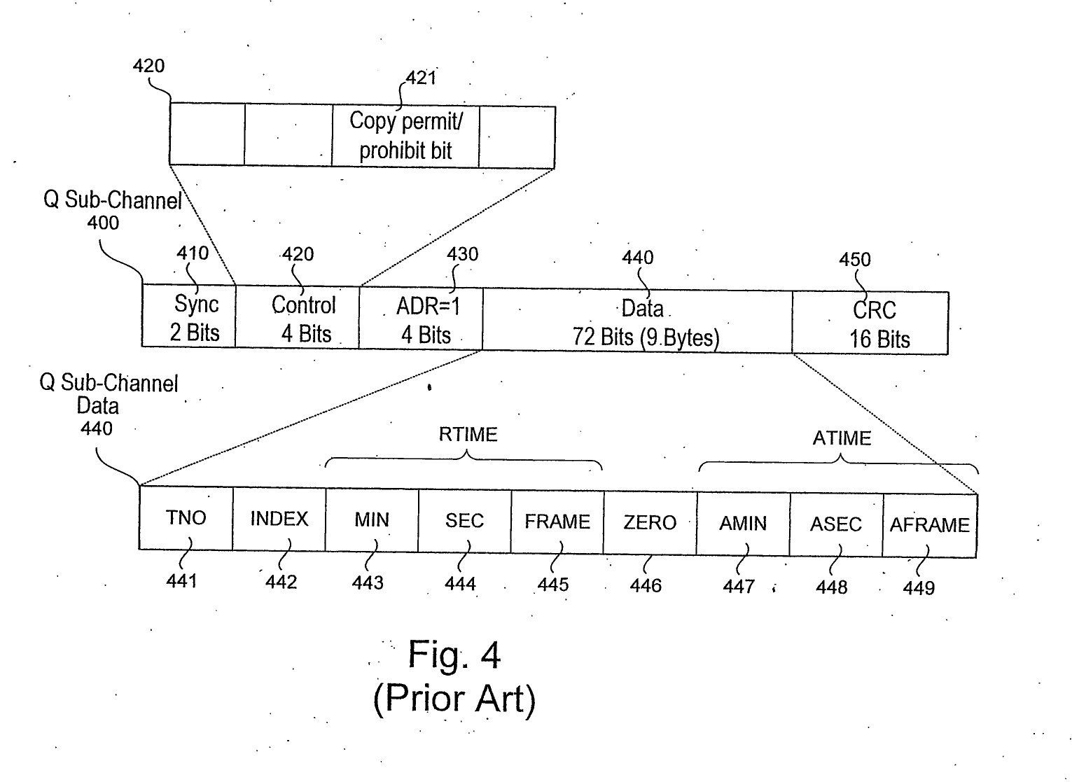

FIG. 4 schematically illustrates the structure of the Q Sub-Channel. Each CD frame contains 98 bits of Q Sub-Channel information. Field 410 contains the 2 synchronization bits of the 2 Sub Channel synchronization bytes of the frame. Field 420 contains 4 control bits that are used to describe the content type of the CD frame. The control field includes the Digital Copy Permit/Prohibit bit 421, which is used to indicate whether or not the content owner allows making copies of the content stored on the current track indicated by the TNO field 441. Typically, all the CD frames within the same track 2210 have the same value in their Digital Copy Permit bit 421. The value of this bit is usually set for each track by the content owner, via the writing software, before writing the content to the CD. The ADR, field 430, contains 4 bits that define the content of the 72 data bits in field 440 and is known as the ‘Q Mode’. The remaining 16 bits in field 450 are used to store a CRC code for the Control 420, ADR 430 and data 440 fields. The only Q Mode that is relevant to the present invention is Q Mode 1. At least 9 out of 10 successive CD frames in the Track Program Area 2212 of a data CD session, hold Q Mode-1 information.

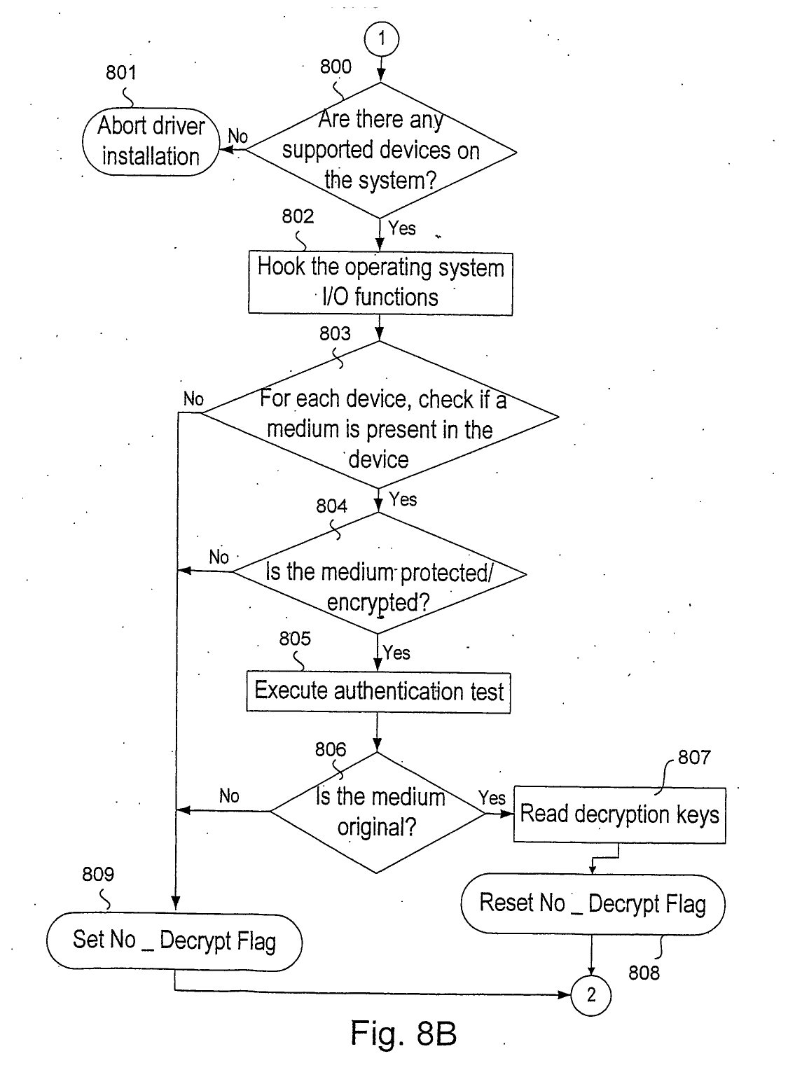

Fields 441 to 449 in FIG. 4, are the 9 bytes that construct the data field 440 of Q Mode-1. The TNO, field 441, holds the track number in BCD. The INDEX field 442 is used for indexing the frames within the track according to the track section to which they belong. The value of the INDEX field in the first track should be 01. In the Pre-Gap of the Track 2210, the track number TNO 441 is the number of the current track, and the value of the INDEX field 442 is 00. Fields 443 to 445 (MIN, SEC, FRAME) are used to denote the relative time of a frame 100 within the Track 2210, which is also known as RTIME (encoded as 6 BCD digits). The RTIME of the first frame in the Track 2210 is 00:00:00 and its value is advanced in each frame 100 through the Track, as shown in FIG. 7. In the Pre-Gap 2211 the RTIME value of each successive frame is decreased. The ZERO field 446 is reserved and set to zero. Fields 447 to 449 (AMIN, ASEC, AFRAME) are used to denote the absolute time address of the frames within the program area, which is also known as ATIME (expressed in 6 BCD digits).

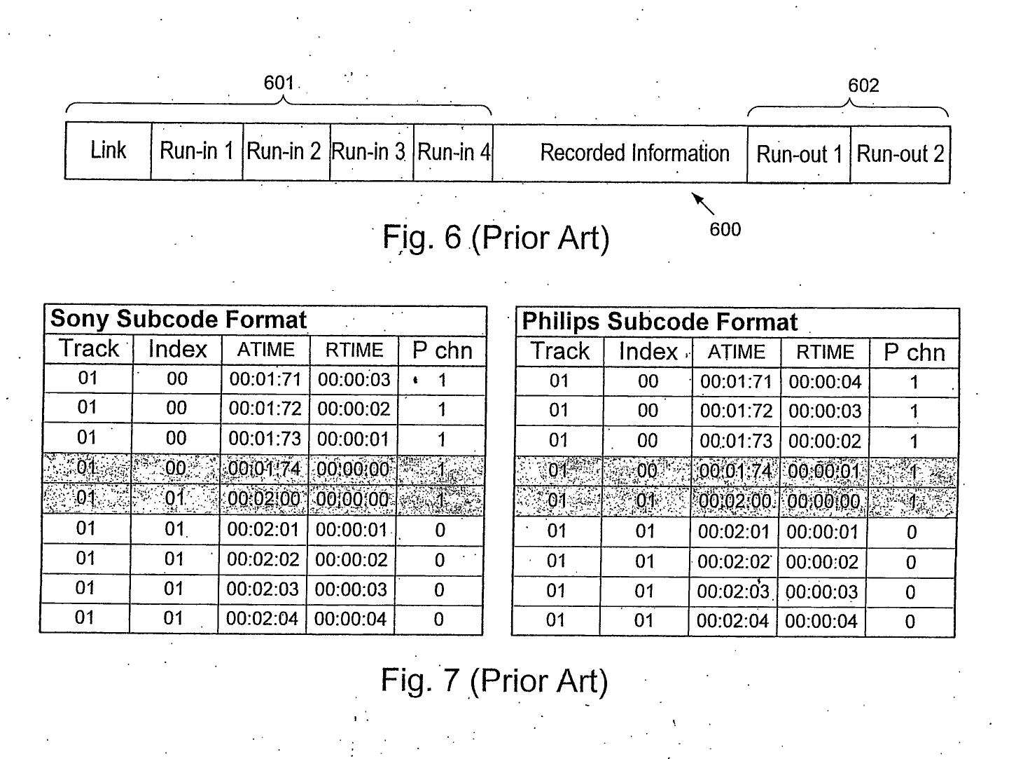

FIG. 5 schematically illustrates the layout of recordable discs. CD-R/RW discs have two additional areas prior to the first Lead-in, the Power Calibration Area (PCA), and the Program Memory Area (PMA). The PCA is present only in CD-R and CD-RW media for the purpose of write power calibration. The PCA is divided into two areas: the test area and the count area. The PMA is present only in CD-R and CD-RW media for the purpose of accounting for the usage of user data areas on the medium. Whenever the recording is stopped, the recorder automatically adds a record to the PMA with the exact address of the next writeable CD frame.

Before starting a write operation, the “write mode page” parameters of the recording device must be set. The “write mode page” is an internal parameter table, that is used to control the writing functionality of the recording device e.g., the writing method, writing speed, the type of content that is written (Audio, Data, etc.).

There are 3 basic methods of writing to a recordable disc. Track At Once (TAO), Session At Once (SAO) and Disc At Once (DAO).

When writing information in TAO, each track is recorded in separate recording operation and the laser beam of the recorder is turned off after the recording of each track is completed. When writing in SAO, all the tracks in each session are recorded in an uninterrupted operation, and the laser beam of the recorder is not turned off after recording each track. Each session is still recorded in a separate operation, and the laser beam is turned off only after the recording of each session is completed.

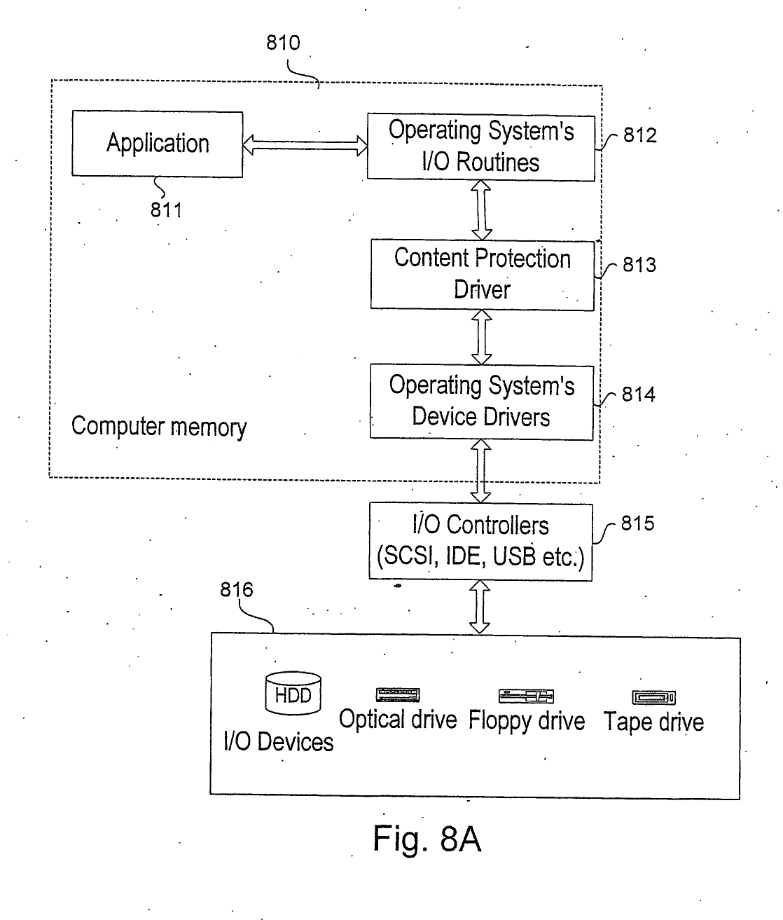

DAO is the only true uninterrupted recording method. When writing in DAO, all the information on the disc from the first Lead-in to the last Lead-out, will be recorded in one uninterrupted operation without turning off the laser beam until the last session is written. As will be explained herein later, the writing method affects the structure of the data on the disc. To gain a better understanding of these effects, the following terms should be explained:
Link Blocks—these are CD frames (100) that are automatically written by the recording device when the laser beam is turned on and before it is turned off. The Link Blocks are used by the recorders as a linkage for appending new recording information, and by the reading devices for finding the exact boundaries of the CD frames 100. It should be noted that it is impossible to prevent the recorder from writing the Link Blocks by software means.
   FIG. 6 schematically illustrates the layout of Link Blocks 601 and 602. When the laser beam is turned on, the CD recorder writes the following 5 CD frames (601): 1 link frame; and 4 Run-in frames (Run-in 1, Run-in 2, Run-in 3 and, Run-in 4). Before the laser beam is turned off, the recorder writes 2 Run-out frames (602: Run-out 1 and Run-out 2). For example, when writing in the TAO writing method, the laser beam is turned on and off before and after the recording of each track, and in this case, the Recorded Information field 600 (shown in FIG. 6) represents a CD Track 2210. When writing in the SAO writing method, the laser beam is turned on and off before and after the recording of each session, and in this case, Link Blocks 601 and 602 will be written only between Sessions 2000, and in this case the Recorded Information 600 represents a CD Session 2000. However, when writing in the DAO writing method, the laser beam is turned on and off only once, and therefore Link Blocks 601 and 602 will not be written between Tracks 2210 or Sessions 2000.
Rom Skew—this is the time difference between the ATIME in the Q Sub-Channel 400, and the ATIME in the Main Channel Header field 112. A CD reader uses the Q Sub-Channel 400 to seek to any location on a CD. Once the address is found in the Q Sub-Channel, the reader switches to the Main Channel and searches in the Header of the frame for the same ATIME address. High value of Rom Skew will result in a slow read accesses, while negative value may cause serious incompatibility issues with existing CD readers. The Rom Skew number for a given disc is the result of the decision an encoder makes while creating that disc, whenever using an encoder in standard CD writer, or an encoder that drives professional mastering equipment in a CD manufacturing facility.
Subcode format—The Subcode format relates to the format of the RTIME frame addresses in the region of a track in which the value of the index field is 0 (the Pre-Gap 2211). There are 2 possible Subcode formats, Sony and Philips. The main differences of these Subcode formats are shown in FIG. 7. The RTIME value of successive frames is specified to decrement within the region of the track in which the value of the index field is 0. In the Philips format the value of the RTIME is decremented down to 00:00:01 (MM:SS:FF) and and it reaches 00:00:00 value only when it reaches a frame in which the value of the index field is 1 (in the Track Program Area 2212). At that point, the value of the RTIME is incremented by one in each successive frame. On a disc that is written utilizing the Philips Subcode format, there is only one frame having RTIME value of 00:00:00, this is the frame where the value of the index filed changed from 0 to 1. In the Sony format the value of the RTIME is decremented down to 00:00:00 in successive frames in which the value of the index field is 0, and the RTIME value of the first frame of the Track in which the value of the index field is 1 is also 00:00:00. At that point, the RTIME value begins to increment by one in each successive frame. On a disc that is written with the Sony Subcode format there are two RTIME values of 00:00:00 in a Track, where the transition of value of the index field form 0 to 1 occurs. Like the Rom Skew, the Subcode format of a disc is determined by the encoder that is used to record the disc.

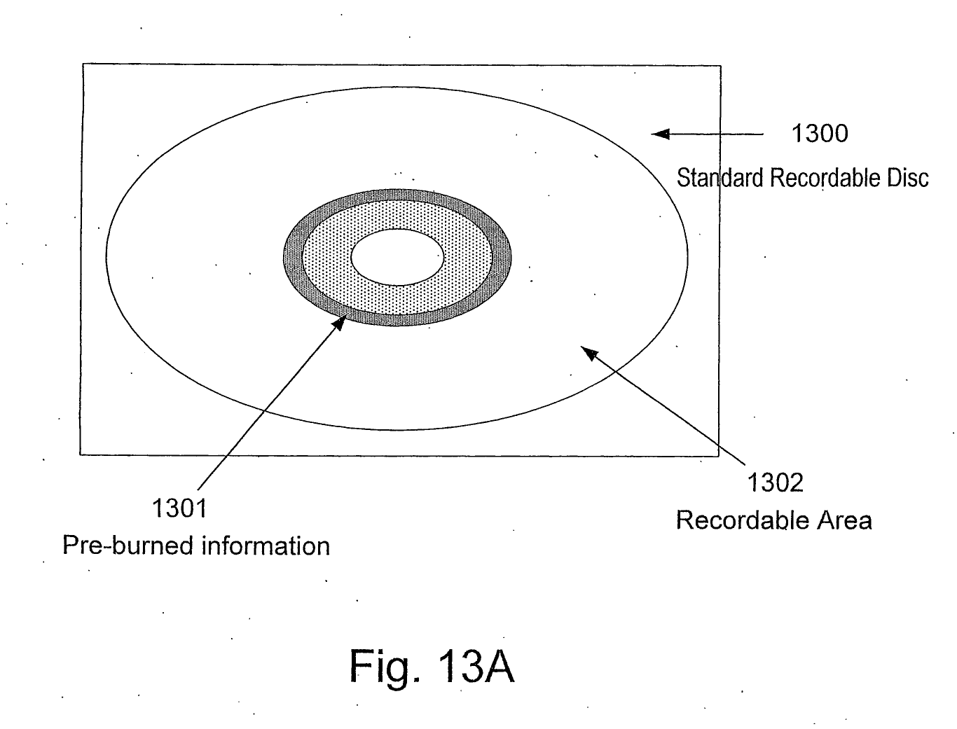

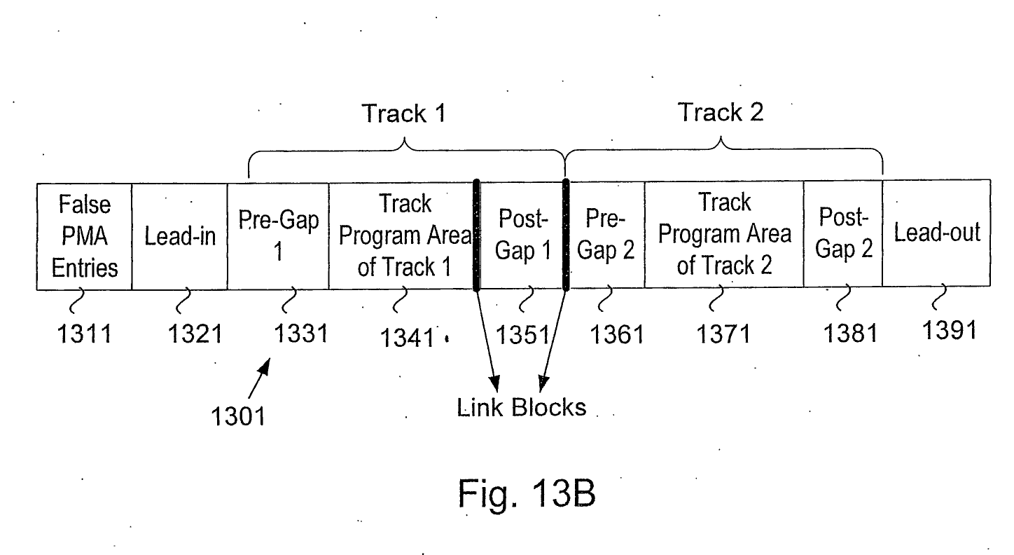

FIG. 13A illustrates the structure of a recordable disc with a pre-burned area that contains intentionally embedded logical symbols according to the preferred embodiment of the invention. The disc 1300, is a standard recordable disc in which a portion of pre-burned information, marked as 1301, is added by burning the first session of the disc with a unique pattern, as will be described hereinbelow. The pre-burned information 1301 is added in a way which allows adding additional information to the recordable area 1302 of the disc 1300 in one or more sessions by means of burning using any standard recorder. This is achieved by leaving the disc “open”. In a multi-session disc, it is possible to add additional sessions as long as there is enough free space on the disc and the disc is “open”. In order to leave the disc “open”, the burning software must specify the next possible write address in the Lead-in of the last recorded session. If this value is missing or set to FF:FF:FF then the disc is closed and it is not possible to add additional sessions to it.

FIG. 13b illustrates the structure of the pre-burned information 1301. The pre-burned information 1301 is a session with two tracks, Track 1 and Track 2. The Pre-Gap of the first track 1331, includes CD frames with the following intentionally embedded logical symbols:
False Track Descriptors—The Pre-Gap 1 field 1331, contains several CD frames with Track Descriptors that intentionally describe Track 1 improperly and do not correspond with standard recording methods. When making a copy of the disc 1300, these false Track Descriptors will be replaced by zeros or new Track Descriptors that describe properly the track and the recording method that is being used.
“Custom Information” in the Pre-Gap area—The Pre-Gap 1 field 1331 of the pre-burned information, contains several CD frames which includes unique patterns which are termed herein as “Custom Information”. The “Custom Information” patterns do not conform with the conventional Track Descriptor structure. When a copy attempt of a disc including these “Custom Information” patterns is carried out, the recorder will typically replace these “Custom Information” patterns with zeros or legitimate Track Descriptors, depending on the recorder and the recording method that is being used.

In a preferred embodiment of the invention the Track Program Area of Track 1, field 1341, includes CD frames with the following intentionally embedded logical symbols:
The CD frame located at the relative address 00:02:16 of the first track, Track 1, contains an Identification Mark(s), in fields that are unused according to the ISO 9660 standard. According to the ISO 9660 standard, this specific frame address is used for storing miscellaneous data regarding the recorded CD. The existence of these Identification Marks indicates that the disc 1300 is a copy protected recordable disc, according to the present invention, on which copy protected and encrypted digital content may be stored.
Digital Silence—Standard recording devices are not designed to record CD frames with Digital Silence. When making a copy of the disc 1300, the Digital Silence frames will not be copoed, due to the reformatting of the CD frames that is preformed by the internal encoder of the recording device.
Rom Sync Shift—Recording devices are not designed to record CD frames with Rom Sync Shifts. Whenever attempting to copy the content of the protected disc 1300, the synchronization pattern 111 (shown in FIG. 1) of each CD frame that exhibits a Rom Sync Shift, is restored to conform with the sync pattern 111.
Serial#A—Two Unique serial numbers are added to the pre-burned information 1301. The first one, Serial#A (copy-seal), is written into one or more CD frames of the Program Area of Track 1. Serial#A is written as standard information in the User Data field of the CD frame (field 113 in FIG. 1). This assures that Serial#A will be transferred to any copy of an original disc that is made. Since the pre-burned information 1301 is added to the disc by means of recording and therefore it is possible to write a unique Serial#A to each protected disc that is being recorded. Serial#A is utilized for tracking pirates as will be explained hereinafter.
Serial#B—The individual bits of the second serial number, Serial#B (copy-authentication), are written to the Digital Copy Permit bits 421 of a sequence of several CD frames in the Track Program Area (2212) of Track 1. In this way one bit of Serial#B is written to the Digital Copy Permit bit 421 of each CD frame in a sequence of frames in Track 1. Thus, the Track 1 that is burned in the first session of the copy protected CD is set to contain several CD frames having varying values in their Digital Copy Permit bits 421. Whenever an attempt to copy the content of the copy protected disc 1300 is made, the varying values of these bits (421) (on the original disc 1300) will be replaced with one constant value for all of the Digital Copy Permit bits 421 in Track 1 of the recorded copy.

According to one preferred embodiment of the invention, the Pre-Gap 1, 1331, of Track 1 is recorded according to the Philips Subcode format, while Pre-Gap 2, 1361, of Track 2 is recorded according to the Sony Subcode format. In this way, whenever an attempt to copy the content of the copy-protected disc 1300 is made, both Pre-Gap areas, 1331 and 1361, of the recorded copies will be recorded according to one Subcode format that is determined by the recording device.

The pre-burned information 1301 also contains Link Blocks between Post-Gap 1, 1351, of Track 1, and the Pre-Gap 2, 1361, of Track 2. Additional false Link Blocks are intentionally written in the middle on the Track Program Area (2212) of Track 1, where Link Blocks are not written when using standard recorders and recording methods. These Link Blocks are fake Link Blocks that are written instead of standard CD frames within the Program Area of track 1. When making a copy of the disc 1300, Link Blocks are written according to the recording method that is used to make the copy. Therefore, the false Link Blocks within the Track Program Area of Track 1 will not be copied to the recorded copy. Additionally, the Link Blocks between field 1351 and field 1361 may not appear on the copy as well if the copy is recorded in one of the uninterrupted recoding methods (SAO or DAO).

Each of the Link Blocks in FIG. 13B comprise a sequence of blocks, 602 and 601, each of which has the structure as shown in FIG. 6. It should be noted that these recorded structures can not be read by conventional CD readers. Therefore, any attempt to copy such recorded structures will result in the recording of unpredictable content. Of course, additional Link Blocks may be generated by the recorder depending on the recording method that is used to record a copy.

Except for the logical symbols that are listed above, the PMA area of the disc 1300, contains intentionally embedded false PMA Entries 1311 that do not match the layout of the disc. An example for a false PMA entry is one that lists an address of a CD frame that is within the Track Program Area of track 1. This is not a true PMA entry because PMA entries are written only when the recording is stopped and recorders are not designed to stop the recording in a middle of a track, and then continue the recording within said track. When attempting to make a copy of the disc 1300, the recorder will add to the copy, PMA Entries that match the disc layout and the recording method, and the false PMA Entries will not exist on the copy.

These intentionally embedded logical symbols, together with the Disc ID, the Lead-in Start Time and the Rom Skew value of the pre-burned information, are used to authenticate original discs and for protecting digital contnet from illegal copying and use by means of encryption. The content to be protected is added to the recordable area 1302, as will be explained hereinafter.

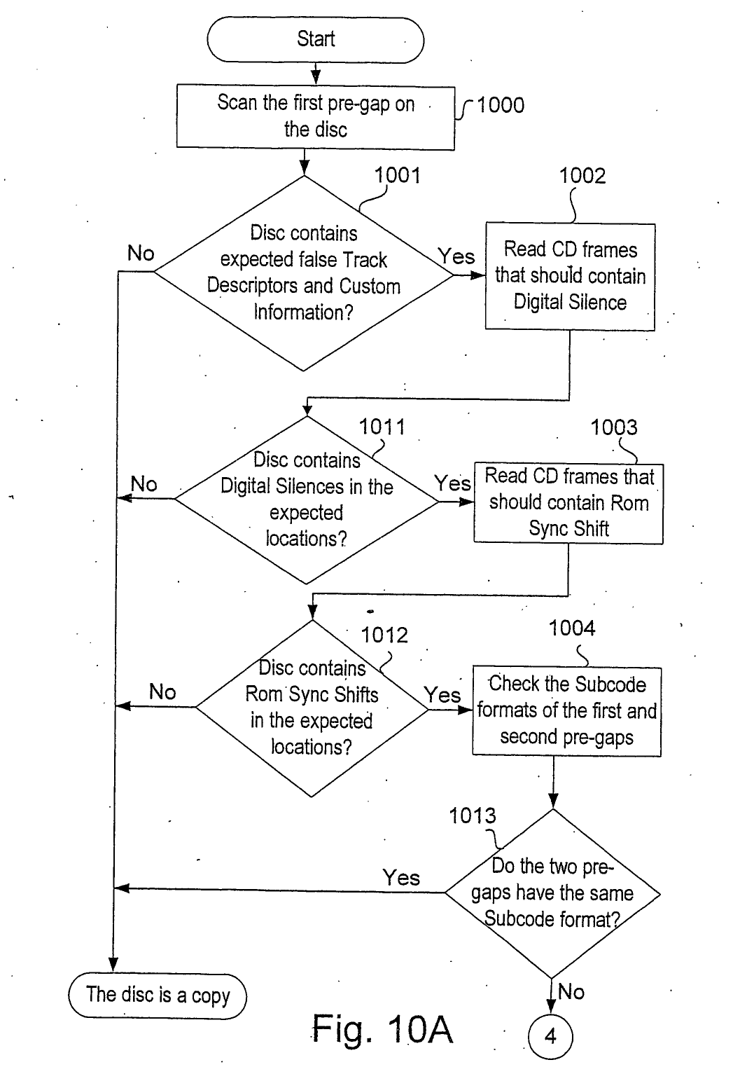

FIG. 9 illustrates a process of authenticating a recordable CD, utilizing unique Identification Marks that exist on any recordable disc. The process starts in step 900 in which the Disc ID is read from the disc. In step 902 the Lead-in start time is read from the CD. In step 903 the values that were read in steps 900 and 902 are compared to the expected values that should be read from an original CD. If the read values equal to the expected values, then the CD is an original. Otherwise, the CD is a copy. By using an authenticating software which carries out this authentication process, where said authenticating software is provided with the Disc ID and the Lead-In Start Time expected values, it is possible to determine if the medium on which said authenticating software is stored is original, and continue or terminate its operation accordingly.

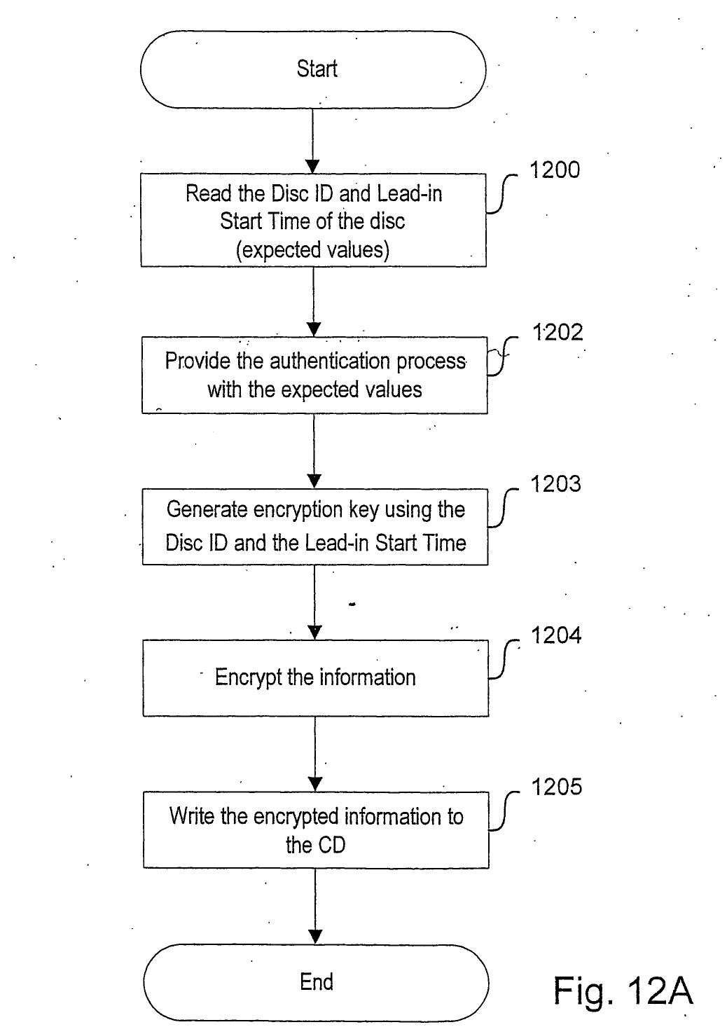

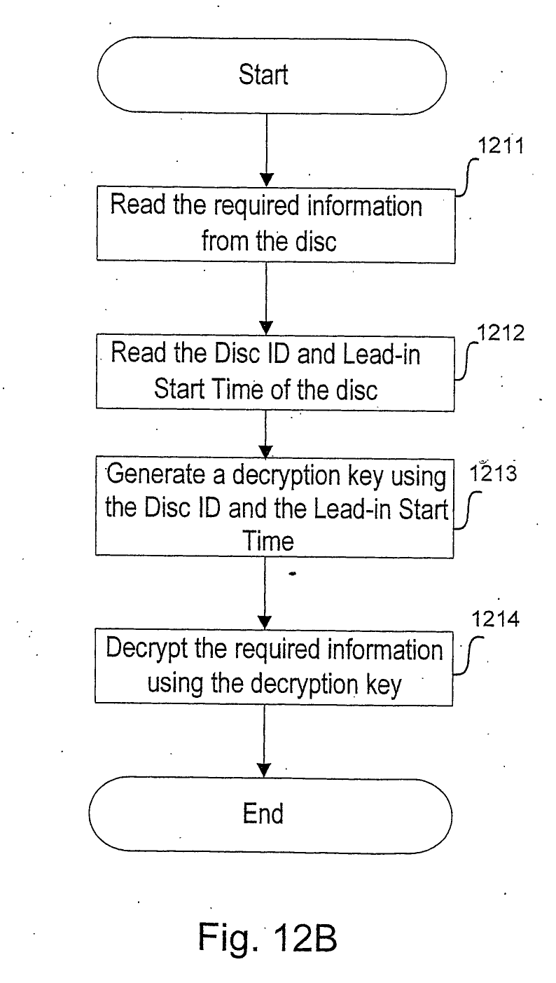

FIGS. 12A and 12B illustrates a method for protecting digital contnet stored on a standard recordable disc from illegal copying by means of encryption. FIG. 12A illustrates the encryption process and FIG. 12B illustrates the decryption process that takes place whenever protected content is read from a disc produced by the protecting method illustrated in FIG. 12A.

The encryption process starts in step 1200 in FIG. 12A, in which the Disc ID and the Lead-in Start Time are read. In step 1202 the expected values of the authentication process (shown in FIG. 9) are set. The expected values are used by the authentication process that is integrated into executable program files, as shown in step 903 of the process illustrated in FIG. 9. Step 1202 is carried out by replacing fixed values within the executable program files with the actual Disc ID and Lead-in Start Time values of the disc to which the files are about to be written. In step 1203 an encryption key is generated using the Disc Id and the Lead-in Start Time. The encryption key is generated by manipulating the Disc Id and the Lead-in Start Time values utilizing mathematical and/or logical operations, and/or by utilizing some predetermined sequence of permutations acted on said values or on the result of a mathematical and/or logical operations performed upon them. For example, the encryption key may be generated by XORing the Disc Id and the Lead-in Start Time values.

In step 1204 the content that is about to be written (i.e., the actual content to be stored) is encrypted using the encryption key that was generated in step 1203. In step 1205 the encrypted content is written to the disc (CD). The encrypted content on the recorded copy become useless in any attempt of making a copy of a disc that contains encrypted content utilizing this method. In order to properly decrypt and use the encrypted content, the exact Disc Id and the Lead-in Start Time values are needed. The chances that the copied disc have the same Disc Id and Lead-in Start Time as the original, are negligible.

FIG. 12B illustrates the decryption process that takes place whenever reading the encrypted content from the disc. In step 1211 the required encrypted content is read from the disc. In step 1212 the Disc ID and the Lead-in Start Time are read from the disc. In step 1213 a decryption key is calculated using the Disc ID and Lead-in Start Time. The calculation process that is used in step 1213 to obtain the decryption key is identical to the process utilized in the generation of the encryption key is step 1203. In step 1214 the required content that was read-in step 1211 is decrypted using the decryption key that was calculated in step 1213. If the disc is original then its Disc ID and Lead-in Start Time values will be used to generate the proper decryption key and the content will be decrypted properly. If on the other hand the disc is a recorded copy then the Disc ID and Lead-in Start Time values should be different from the respective values ont eh original, and therefore, the decryption key that is calculated by the authentication software in step 1213 in such case will be the wrong key, and thus the protected content will not be decrypted properly.

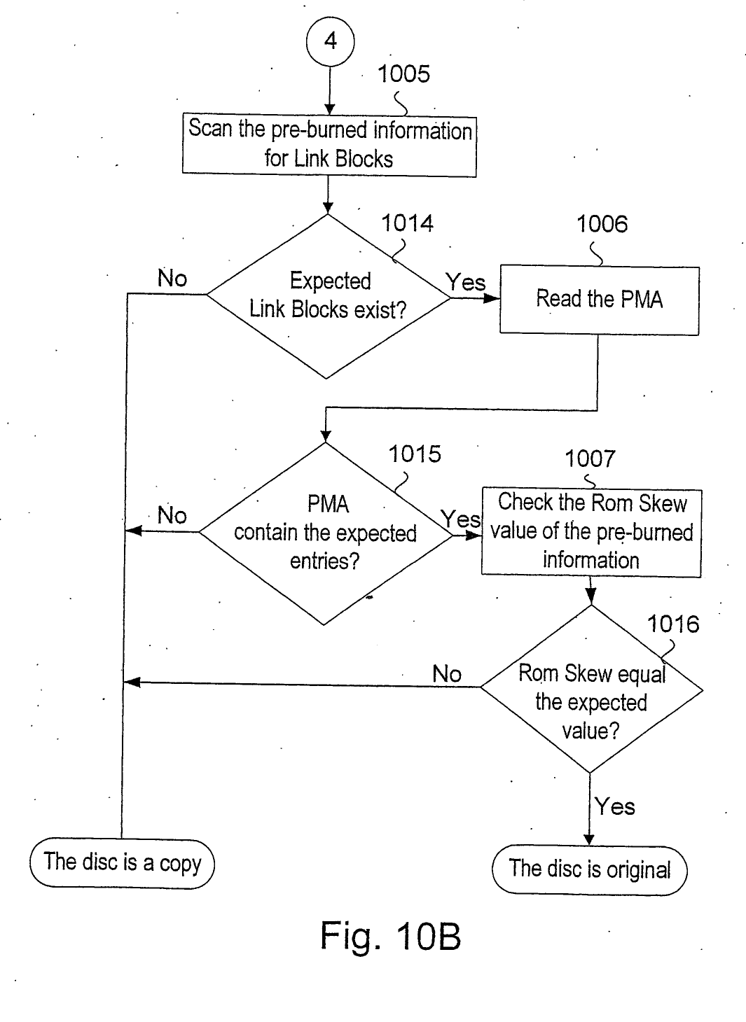

FIGS. 10A and 10B illustrates an authentication process that is performed to a recordable disc that has pre-burned 1301 information according to the present invention, as illustrated in FIGS. 13A and 13B. The process starts in step 1000 in FIG. 10A, in which the first Pre-Gap area, field 1331 (shown in FIG. 13B), is scanned for the false Track Descriptors and Custom Information that exist on an original copy protected disc 1300. In step 1001 it is checked if the expected Track Descriptors and the Custom Information were found during the scanning that were preformed in step 1000. If it is determined in step 1001 that the expected Track Descriptors and the Custom Information were not found then it is determined that the disc is a copy. Otherwise, the control is passed to step 1002.

In step 1002 the CD frames of the Track Program Area of track 1 (field 1341), which exits on an original disc and which should contain intentionally embedded Digital Silence, are read from the disc. In step 1011 it is checked if the CD frames that were read in step 1002 contain Digital Silence. If the frames containing Digital Silence were not found, then it is determined that the CD is a copy. Otherwise, if it is determined that the CD frames that were read in step 1002 contain Digital Silence, then the control is passed to step 1003, in which the CD frames that should contain intentionally embedded Rom Sync Shifts in the Program Area of track 1 on an original disc are read. In step 1012 it is checked if there are Rom Sync Shifts within the CD frames that were read in step 1003. If it is determined that there are no Rom Sync Shifts, then it is determined that the CD is a copy. Otherwise, if there are Rom Sync Shifts, then the control is passed to step 1004, in which the Subcode formats of the first two Pre-Gaps on the disc, fields 1331 and 1361, are determined. In step 1013 it is checked if the said two first Pre-Gaps on the disc have the same Subcode formats. If it is determined that the two Pre-Gaps have the same Subcode format, then it is determined that the disc is a copy. Otherwise, if the different Subcode formats are found on said two Pre-Gaps, then the control is passed to step 1005 in FIG. 10B through \textcircled{4}.

In step 1005 in FIG. 10B the pre-burned information 1301 is scanned for the expected Link Blocks. In step 1014 it is checked if the expected Link Blocks were found in the scan preformed in step 1005. If they were not found, then it is determined that the disc is a copy. Otherwise, if the Link Blocks were found on the disc, then the control is passed to step 1006, in which the PMA Entries of the disc are read from the PMA area of the disc. In step 1015 it is checked if the expected false PMA Entries exist on the disc. If the false PMA entries are not present on the disc, then it is determined that the disc is a copy. Otherwise, if the false PMA entries are present on the disc, then the control is passed to step 1007 wherein the value of the Rom Skew of the pre-burned information 1301 are checked. In Step 1016 it is checked if the actual Rom Skew value that was determined in step 1007 is equal to the expected value that should exist on an original copy protected disc. If it is not so, then it is determined that the disc is a copy. Otherwise, if the Rom Skew value that was determined in step 1007 equals to the expected value then it is determined that the disc is an original.

The authentication process illustrated using FIGS. 10A and 10B, includes all the authentication tests of the present invention. It is not necessary to perform all of these tests to determine the originality of a copy protected disc, One may of course choose to use a less robust authentication procedure that is based on part of the described tests.

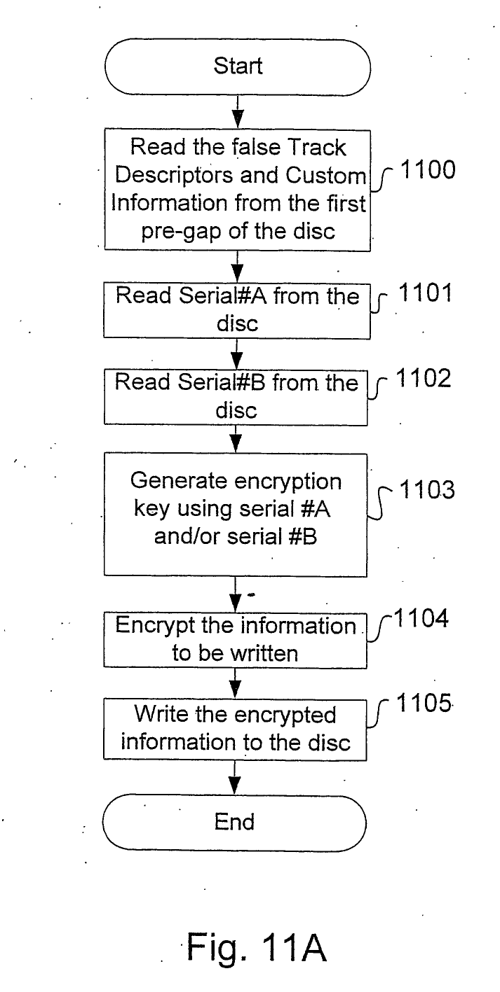

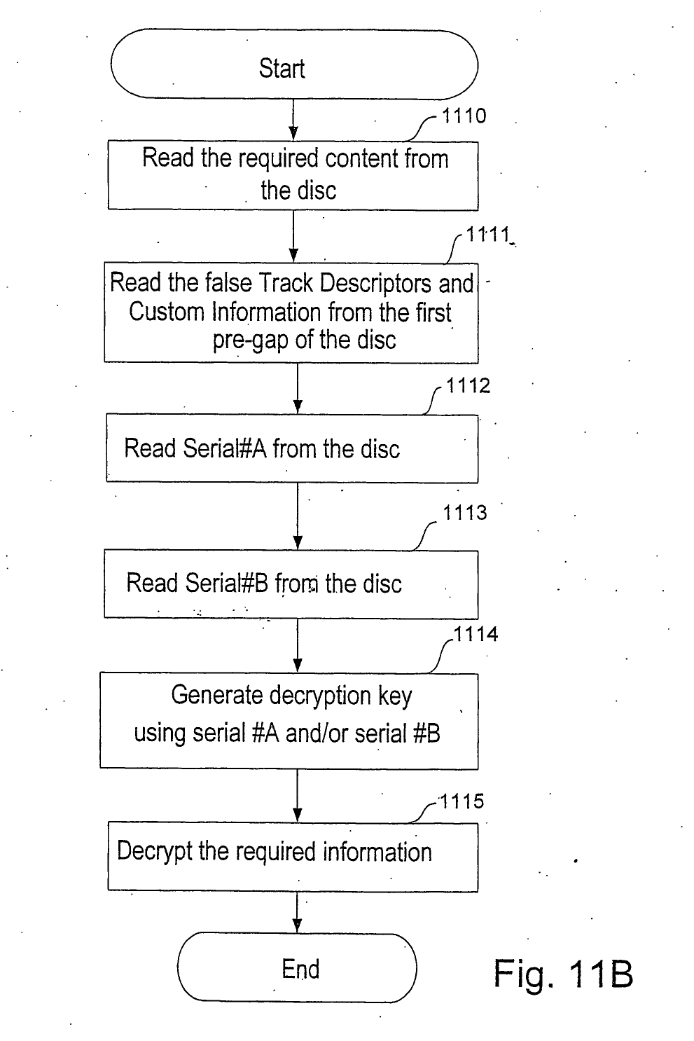

FIGS. 11A and 11B illustrate a method for protecting digital content from illegal copy, utilizing some of the logical symbols and serial numbers that are embedded to the recordable disc 1300. FIG. 11A illustrates the encryption process and FIG. 11B illustrates the decryption process that takes place whenever the recorded content is read from the copy protected disc.

The encryption process starts in step 1100 of FIG. 11A in which the false Track Descriptors and Custom Information are read from the first pre-gap of the disc (field 1331 in FIG. 13B). In step 1101 the unique Serial#A of the disc is read from the Track Program Area of the first track on the disc, field 1341. In step 1102 the unique Serial#B of the disc is read from the Track Program Area of the first track on the disc, 1341, and in step 1103 an encryption key is calculated using some, or all, of the information that was read in steps 1000 to 1002. In step 1104 the digital content that needs to be protected is encrypted using the encryption key that is calculated in step 1103, and in step 1105 the encrypted content is written to the recordable area of the disc, field 1302, in an additional session.

FIG. 11B illustrates the decryption process that takes place whenever content is read from the disc. In step 1110 the required content is read. In step 1111 the false Track Descriptors and Custom Information are read from the first Pre-Gap of the disc (field 1331 in FIG. 13B). In step 1112 the unique Serial#A of the disc is read from the Track Program Area of the first track of the disc, field 1341. In step 1113 the unique Serial#B of the disc is read from the Track Program Area of the first track of the disc, 1341. In step 1114 the decryption key is calculated using the information that was read in steps 1111 to 1113. In step 1115 the digital content that is read in step 1110 is decrypted using the decryption key that was calculated in step 1114. If the disc is a copy then the false Tack Descriptors and the Custom Information should not exist in the first pre-gap of the disc, and the Serial#B should not exist on the disc as well. Therefore, the decryption key that is calculated in step 1114 should be the wrong key and therefore the protected content can not be decrypted properly in such case. On the other hand, if the disc is an original, the right decryption key is calculated in step 1114, and thus the content can be decrypted properly.

The generation of the encryption key and decryption key performed in steps 1103 and 1114 is carried out utilizing some or all of the values that were previously obtained (i.e., serial#A, serial#B, false Track Descriptors, and Custom Information) by utilizing mathematical and/or logical operations, and/or by utilizing some predetermined sequence of permutations acted on said values or on the result of a mathematical and/or logical operations performed upon them.

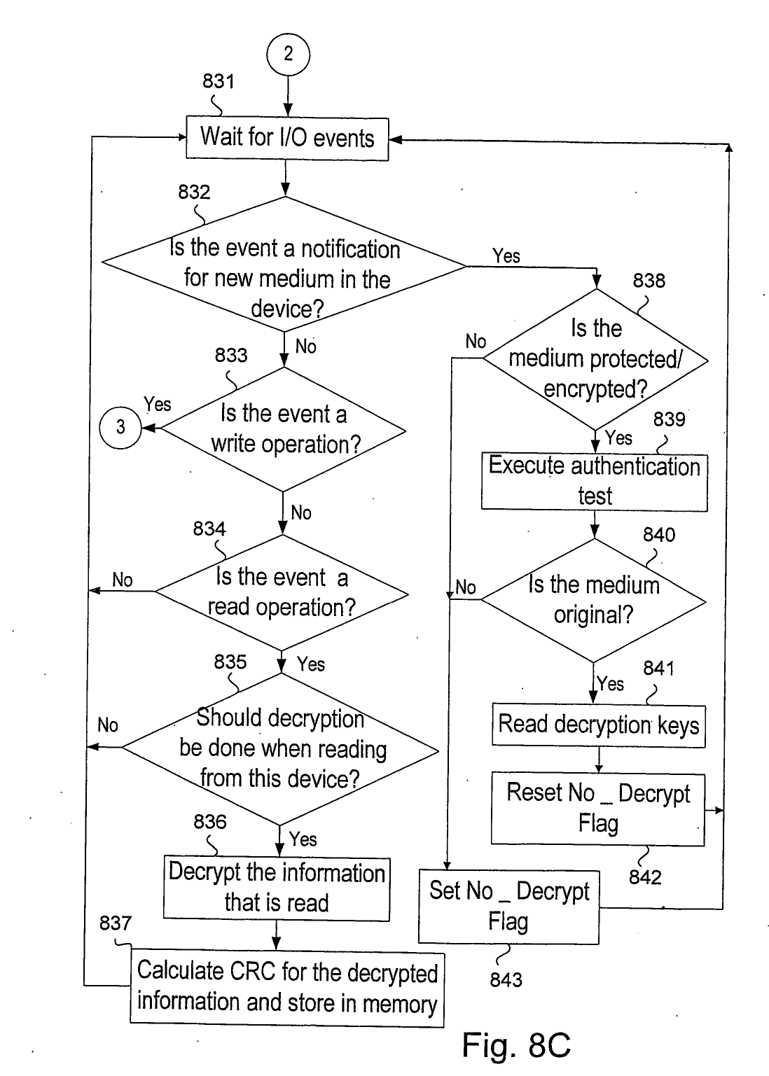

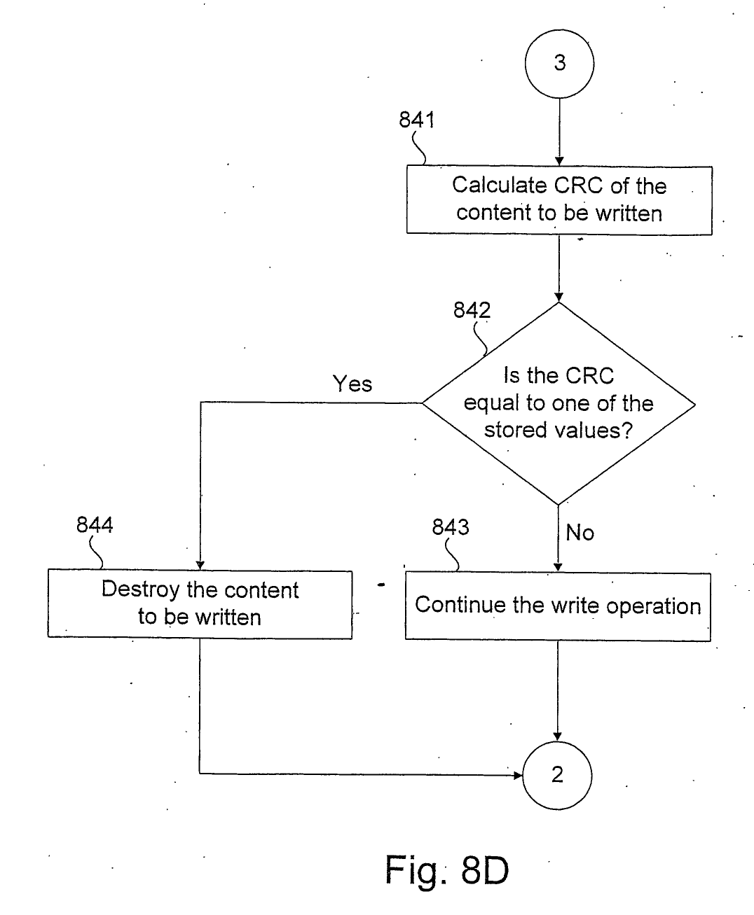

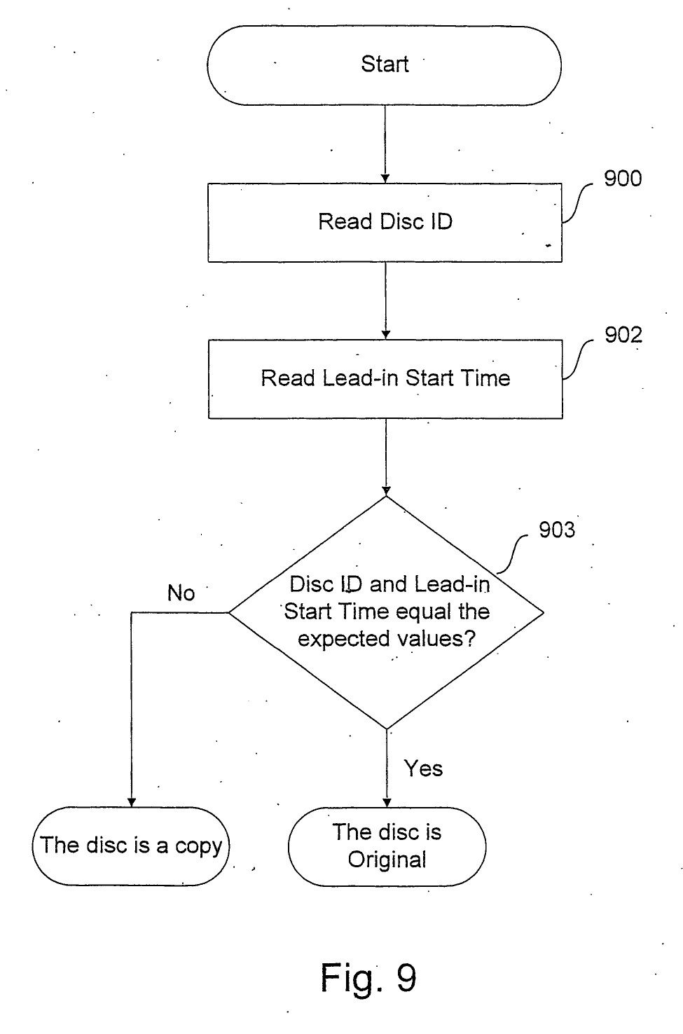

FIG. 8A schematically illustrates the architecture of a computer system that contains a content protection driver 813. The computer's memory 810 holds the operating system software. Any operating system software consists of two main components that manage the access of applications 811 to I/O devices 816. The first component is the Operating System's I/O API's 812 (Input/Output Application Interfaces), and the second component is the Operating System's device drivers 814. In a typical Operating System, running application 811, uses the Operating System's I/O API's 812 to perform Input/Output operations from/to I/O devices 816, via I/O controllers 815. The Operating System's I/O API's 812 uses the Operating System's device drivers 814, to perform the actual Input/Output tasks. Each driver has its own I/O procedures that matches to the device that it manages.

The content protection driver 813 is installed between the Operating System's I/O API's 812 and the Operating System's device drivers 814, in such a way that it is able to intercept any I/O operations and data transfers that are carried out between the I/O devices 816 and the computer memory 810. The placing of the content protection driver 813 in such manner is also termed Hooking.

FIG. 8B illustrates the installation procedure of the content protection driver 813 into the computer Operating System. In step 800, the installation procedure checks if there are any supported I/O devices 816 in the computer system. If there are no supported I/O devices 816, the installation procedure of the content protection driver 813 is aborted in step 801, otherwise, if there are supported I/O devices 816, the control is transferred to step 802. In step 802 the installation procedure Hooks the operating system's I/O API 812 to the installed content protection driver 813. After the operating system's I/O API's 812 are hooked to the content protection driver 813, any I/O request from any application 811 is addressed through the I/O routines of the OS and the content protection driver 813, instead of addressing the OS Device Drivers 814.

It should be noted that the content protection driver 813 is actually a program file that can be stored on the protected medium itself or on a different medium. The installation process is initiated by running this program file.

In step 803 it is checked if there is a medium present in each of the existing supported I/O devices 816. If there is no medium present the control is transferred to step 809 in which a flag (No_Decrypt) is set to indicate that there is no need to decrypt the content that is being read from the specific I/O device. The operation continues as the control is passed from step 809 to the content protection driver's main loop through \textcircled{2}.

If it is determined in step 803 that a medium is present in one of the supported I/O devices 816, the control is passed to step 804. In step 804 it is checked if the content on the medium is encrypted. This check is dependent on the medium type. In case of a CD, it is done by reading the CD frame at the relative address 00:02:16 of the first track. As was explained before, according to the encryption process of the present invention this CD frame is used for storing an Identification Mark, in fields that are unused according to the ISO 9660 standard. The existence of the Identification Mark indicates that the medium is protected and its content is encrypted. If the content on the medium is not encrypted, then there is no need to perform decryption of the stored content that is read from the specific I/O device and the control is passed to step 809. If the content is encrypted, the process continues in step 805, wherein an authentication test is performed to determine if the medium is an original or not. The authentication test is also dependent on the medium type. In case of a recordable CD this authentication test can be one of the authentication tests of the present invention, illustrated in FIGS. 9, 10A and 10B.

In step 806 the result of the authentication test of step 805 is checked. If it is determined in step 806 that the medium is not an original, the decryption of the content that is read from the specific I/O device should not be decrypted, and the control is passed to step 809. Otherwise, if it is determined in step 806 that the medium is an original, the control is passed to step 807, wherein the appropriate decryption keys are read from the medium. Then the control is passed to step 808, which resets the No_Decrypt flag to indicate that the content that is read from the specific I/O device need to be decrypted. The control is then passed to the main loop through \textcircled{2}. The decryption keys required to decrypt the protected content are stored on the storing media in predetermined locations which are determined according to the storing media that is being used. For example in a CD encryption keys may be calculated using the values of Serial#A and Serial#B, and the Custom Information in the pre-gap.

FIG. 8C illustrates the process carried out by the main loop of the content protection driver 813. In step 831 the process enters a wait state, until an I/O event that is generated by an I/O operation is identified using the Hooks that were set up in step 802. When an I/O event is generated, the control is passed to step 832, in which it is checked if the event is generated due to a new medium that was inserted to one of the supported I/O devices 816. If a new medium was inserted, the control is passed to step 838 in which it is checked if the new inserted medium is protected. The test performed in step 838 is identical to the test performed in step 804. If the medium is not protected then the control is passed to step 843 wherein the NO_Decrypt flag is set to indicate that there is no need to decrypt the content that is read from the specific I/O device. The control is then passed to step 831 in order to wait for the next I/O event.

If it is determined in step 838 that the new inserted medium is protected, then the control is passed to step 839, in which an authentication test is performed on the medium. The test in step 839 is identical to the test preformed in step 805 in FIG. 8B. The results of this authentication test are checked in step 840, and if it is determined that the medium is not an original, then there is no need to decrypt the content that is read from the specific medium and the control is passed to step 843. Otherwise, if it is determined that the medium is an original, the control is passed to step 841 in which the appropriate decryption keys are read from the medium. In the next step, 842, the No_Decrypt flag is reset to indicate that the content that is read from the specific I/O device should be decrypted.

If it is determined in step 832 that new medium was not inserted, then the control is passed to step 833, in which it is checked if the event was generated due to of an intercepted write operation, and if it is so, then the control is passed to the write procedure (shown in FIG. 8D) through \textcircled{3}. Otherwise, if it determined that the event was not generated due to an intercepted write operation, then the control is passed to step 834 in which it is checked if the event was generated due to an intercepted read operation.

If it is determined in step 834 that the event was not generated due to an intercepted read operation, then the control is returned to step 831, in which the process enters a wait state, and waits for the next event. If it is determined in step 834 that the event was generated due to an intercepted read operation, the control is passed to step 835, in which it is checked if the read content should be decrypted by checking the state of the No_Decrypt flag of the specific I/O device. If decryption should not be preformed (No_Decrypt=“1”), then the control is returned to step 831, for waiting for the next event. Otherwise, If decryption should be preformed (No_Decrypt=“0”), then the control is passed to step 836 in which the read content is decrypted. The process proceeds in step 837, in which a CRC code for the read content is calculated, and the CRC result is then stored in the computers memory. This step also manages a list of CRC codes of all the content that was read in the recent read operations. Finally, the control is returned to step 831 that waits for the next event.

FIG. 8D illustrates the write procedure that is initiated in step 833 (FIG. 8C). In step 841 the CRC code of the content that is about to be written is calculated, And in step 842 it is checked if the calculated CRC code obtained in step 841 equals to one of the CRC codes that were calculated for the content that was read in the recent read operations. It is done by checking the CRC Codes in the list that is managed in step 837 in FIG. 8C. If the calculated CRC equals to one of the CRC values in the list, then the control is passed to step 844 that destroy the content that is about to be written by overwriting it with meaningless random information.

If it is determined in step 842 that the calculated checksum that was obtained does not equal to one of the checksums that were calculated for the content that was read in the recent read operations, then the control is passed to step 843, in which the write process is allowed to continue normally. Eventually, the control is passed back to step 831 in the main loop of the content protection driver through \textcircled{2}.

The protection against copying of protected content can be further improved to prevent such copying by any active process. For example, step 837 may include setting a flag associated with the process which initiated the read event. In this way whenever a write operation is performed by this process it can be prevented in step 842 by checking the status of the flag associated with process which initiated the write event. A determination that the flag associated with process which initiated the write event is set “ON” will result in preventing the write operation in step 844. It should be noted that this additional protection can be used to prevent any output (e.g., print, paste, etc.) from the initiating process.

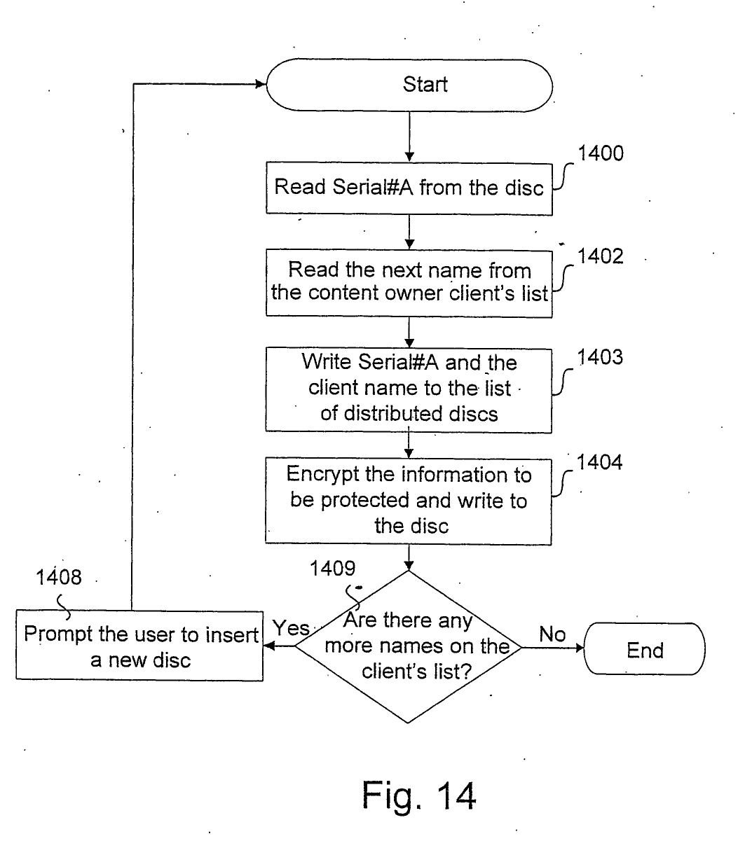

FIG. 14 is a flowchart illustrating a process for managing clients' distribution lists, that has in it the client's information, such as his name and address, and the Serial#A of the pre-burned disc 1300 that the specific client is about to receive. The system takes the client's information from a clients list and creates for him a unique disc. The system also adds to a list distributed discs, all the clients' information and the respective Serial#A code of the disc that was created for them. In step 1400, Serial#A is read from the pre-burned disc 1300, and in step 1402 the information of the next client is read from the clients list. In step 1403 the Serial#A and the information of the client, that was read in step 1402, are added to the distributed discs list. In step 1404 the content to be protected is encrypted and written to the disc using the process illustrated in FIG. 11A. In step 1409 it is checked if there are additional clients in the clients list. If not, the process ends, otherwise, the control is passed to step 1408 in which the operator of the system is prompted to insert new recordable disc 1300 to the recorder.

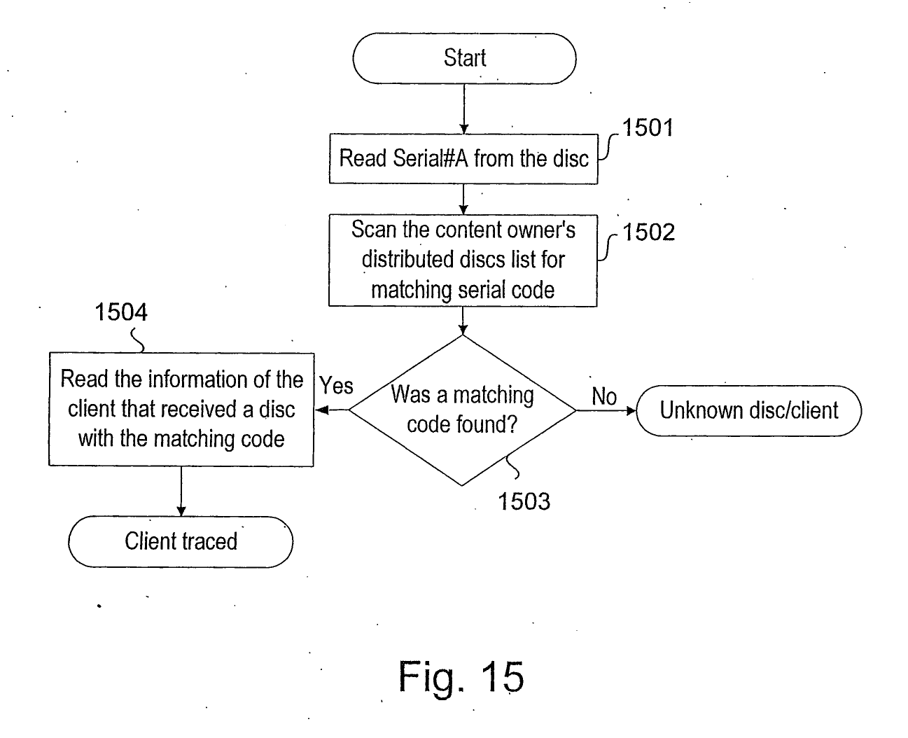

FIG. 15 illustrates a process for tracing pirates. Should an illegal copy of a copy protected medium 1300 with serial numbers be found, it is possible to use the protection method of the invention for tracing the owner of the original disc, from which the copy was made. The system reads the Serial#A code from a copy of a serialized medium (i.e., which was copied from a protected disc 1300) and matches it to one of the clients in a distributed discs list. In step 1501 Serial#A code is read And in step 1502 the distributed discs list is scanned for a record with a matching Serial#A code. In step 1503 it is checked if a record with a matching Serial#A code was found during the scan in step 1502, such record was not foun then it is determined that the copy was made using a disc that does not appear on the list of distributed discs and the process terminates. Otherwise, if a matching record was found, the control is passed to step 1504 in which the information of the client is read from the matching record. The content owner can use this information to identify the person who received a legitimate copy which was used to make at least one illegal copy.

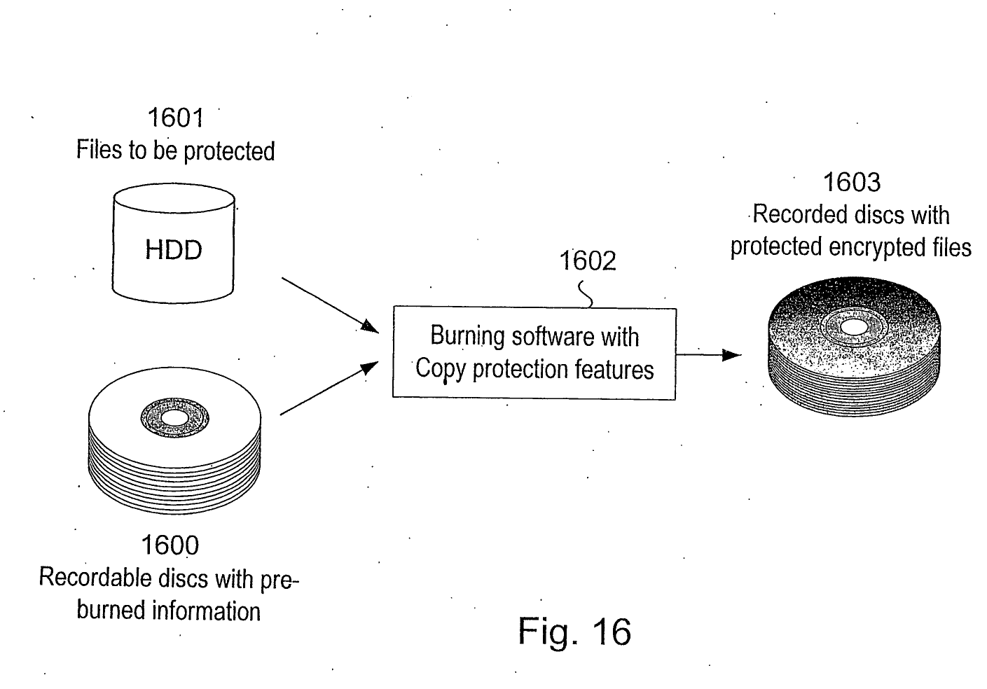

FIG. 16 illustrates the use of the copy protection system of the present invention by any content owner that wants to protect its content form illegal copying. The content owner uses discs with pre-burned information, as illustrated in FIG. 13. These discs are marked as item 1600 in FIG. 16. These are the discs on which the content to be protected 1601 will be recorded. The burning software 1602 uses the encryption process illustrated in FIG. 12A to encrypt the files to be protected before writing them to each disc. The software can also use the process illustrated in FIG. 14 if the content owner wish to manage lists with tracking information. If the files (content) to be protected are program files, then the program files can have the authentication process illustrated in FIGS. 10A and 10B integrated into them. This authentication process determines if the disc is original or not, accordingly the execution of each program is terminated or continued. If the files to be protected are content files other than programs, then the files are simply encrypted utilizing the encryption keys established from each disc (Track Descriptors and Custom Information in the first Pre-Gap and the serial numbers Serial#A and Serial#B, as explained using FIG. 12A). The result of the process are discs with encrypted content written to what was the recordable area before the process began (field 1302 in FIG. 13). In order to use the encrypted files on the recorded discs, each user will have to install the content protection driver on his computer if it is not already installed. The content protection driver is not needed in case the protected files are program files, that can perform the authentication process and decryption routines by themselves.

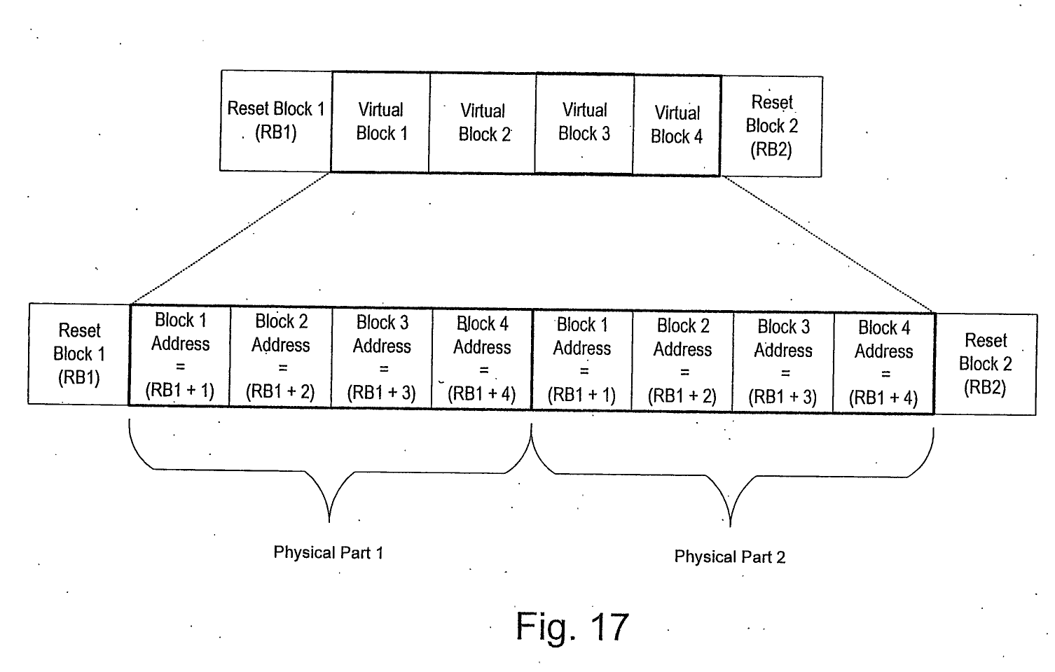

FIG. 17 schematically illustrates the structure of a Virtual Digital Hologram (VDH), that can be used for authenticating a digital storage medium. Storage mediums are divided into information blocks, also known as sectors, which allow efficiently reading the stored information. Each sector has a unique identifying address. With this identifying address it is possible to access a specific sector and read its content.

The VDH section of the storage medium comprises several consecutive information blocks (sectors), which are divided into 2 parts (FIG. 17, Physical part 1 and Physical part 2). The first part of the VDH includes information blocks having addresses RB1, RB1+1, . . . , RB1+4. The second part of the VDH includes a set of overlapping information blocks with the same addresses RB1, RB1+1, . . . , RB1+4. The overlapping of information blocks is realized whenever two or more information blocks on the same medium share the same identifying address. Although the overlapping information blocks have the same address, they contain different information, so that the overlapping information blocks are actually distinct blocks according to their content. VDH can be implemented on recordable or non-recordable media, provided that the media is divided into information blocks having unique identifying addresses.

For example, on a CD, each CD Frame has its address written in 3 different locations: in the ATIME and RTIME of the Q sub channel as shown in FIG. 4, and also in the Header that is presented as block 112 in FIG. 1. In order to create a VDH on a CD, these 3 locations in each overlapping CD Frame must be changed accordingly to indicate the respective identifying address.

The 2 parts of the VDH appear to the reading drive as one virtual part that contain unstable information (e.g., Virtual Block 1 to Virtual Block 4). When the reading drive receives from an application a request to read the content of an information block found in the VDH, the drive may detect 2 different information blocks with an address that matches the address of the requested information. In that case, the drive will access the information block that is physically closest to the location of the drive's reading head. The greater the difference between the distances of the overlapping information blocks from the reading head, the higher the probability that the drive will actually read the nearest information block. If the difference between those 2 distances is minor or zero, then it is unpredictable which of the information blocks will be read.

Making a copy of any digital medium involves 2 basic operations: reading from the source medium and then writing to the target medium. Any copy of a storage medium containing a VDH, will necessarily lack the VDH contained on the source medium. During the reading process, each information block is read and then written to the target medium. However, in the area where the VDH is located there are 2 sets of information blocks (overlapping blocks) that appear as one. When reading this area, only one information block of each set of overlapping blocks will be read and then written to the source. As a result, the target medium will contain in the VDH area only the read information blocks without their overlapping information blocks of the VDH area of the source medium.

There is no way to know for sure which of the overlapping information blocks will actually be copied to the VDH area on the target medium, but the information in this area will necessarily be stable. This means that whenever an application requests the drive to read the content of an information block from a copied medium, the same information block will be read regardless of the drives' reading head's location.

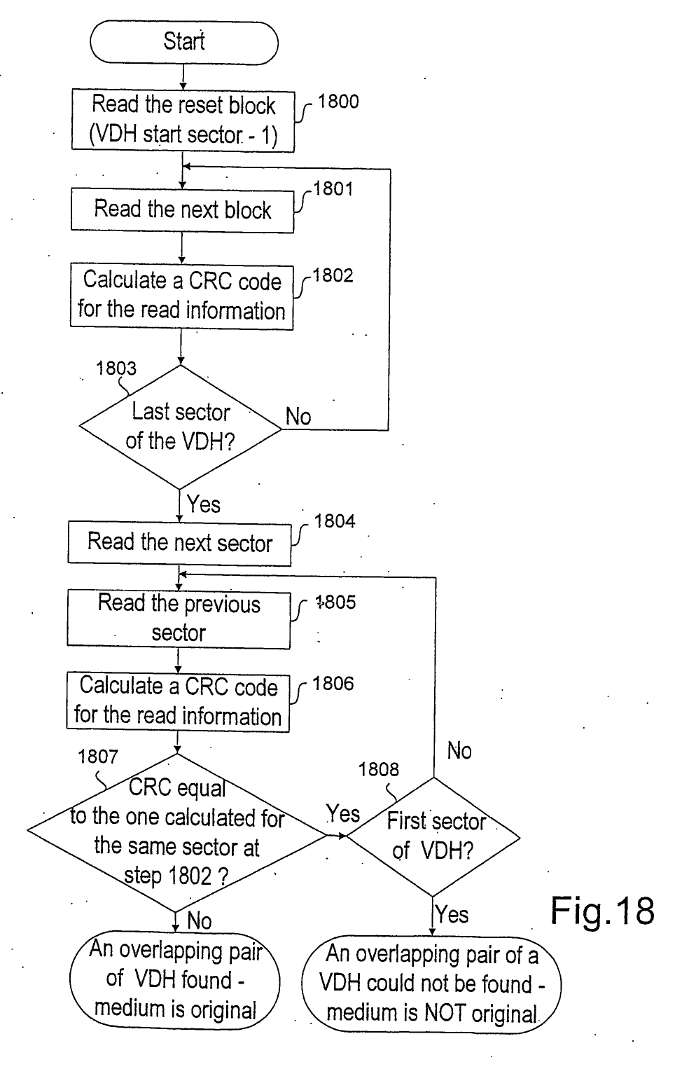

FIG. 18 illustrates a process for authenticating a digital medium that contains a VDH. This authenticating process attempts to read the information blocks (sectors) of the VDH area twice, once “forward” e.g., starting from RB1 and continuing to RB1+1, . . . , RB1+4 and ending in RB2, and once “backwards” e.g., starting from RB2 and continuing to RB1+4, . . . , RB1+1 and ending in RB1.

In step 1800, the first Reset Block (RB1) is read, which is the first sector before the VDH area. Reading this sector brings the drive's reading head to the beginning of the first part of the VDH, wherein the first overlapped sector RB1+1 is located. In step 1801, the next sector is read, which is actually the first overlapped sector RB1+13. In step 1802, a CRC code is calculated for the information read in step 1801, the CRC code is stored in the computer's memory. In step 1803 it is checked if the sector read in step 1801 is the last sector of the first block i.e., RB1+4. If it is determined that the read sector is not the last sector of the first part, the control is passed to step 1801. Otherwise, the control is passed to step 1804.

In step 1804 the next sector is read i.e., RB2(=RB1+5). In step 1805, the previous sector is read (e.g., RB1+4), and in step 1806, a CRC code is calculated for the information read in step 1805. In step 1807, the CRC code calculated in step 1806 is compared to the CRC calculated in step 1802 for the same sector (e.g., RB1+4). If the 2 codes are not equal, then it is assumed that an overlapping sector pair was detected, because different information was read from the same sector addresses in two different read operations. In this case, it is concluded that the medium is original and the process is terminated. In case that the CRC codes compared in step 1807 are equal, then the control is passed to step 1808.

In step 1808 it is checked if the sector that was read in step 1805 is the first sector of the VDH, RB1+1. If it is not the first sector RB1+1 of the VDH, the control is passed to step 1805 for processing the previous sector. Otherwise, if the first sector RB1+1 is reached, it is concluded that the medium does not contain the VDH, because no overlapping sector pair was detected, and therefore, the medium is a copy.

1. A method for preventing the illegal copying of a copy protected content by a computerized system, comprising:
a) installing a driver in the operating system of said computerized system, where said driver is capable of intercepting any attempt of the I/O routines of said operating system to access the device drivers of said Operating System;
b) whenever an attempt to read data from said device drivers is intercepted performing the following steps:
b.1) performing an authentication test to determine if the accessed device contain an original copy, and if it is determined that the accessed device contain an illegal copy terminating the requested I/O operation;
b.2) if it is determined that the accessed device contains an original copy allowing access to said device and calculating and storing in the memory of said computerized system the CRC codes of the data read from said device;
c) whenever an attempt to write data to said device drivers is intercepted performing the following steps:
c.3) calculating CRC code of the data to be written to said device;
c.4) if the calculated CRC code equals to one of the CRC codes that were previously stored in the memory of said computerized system terminating said write data attempt; and
c.5) if the calculated CRC code does not equal to any one of the CRC codes that were previously stored in the memory of said computerized system allowing said write data to be performed.

2. A method according to claim 1, wherein the data stored on the I/O devices is stored in an encrypted form.

3. A method according to claim 2, further comprising decrypting the encrypted data whenever it is determined that the accessed device contains an original copy.

4. A method according to claim 3, wherein the decryption keys are obtained from the I/O device from which the encrypted data was read.

5. A method according to claim 1, further comprising:
setting a flag to a logical ON state whenever an attempt to read data from the device driver is intercepted, where said flag is generally in a logical OFF state and it is associated with the process that initiated said read attempt; and
checking the status of the flag associated with a process attempting to output data and preventing said data output if said flag is in the logical ON state.

6. A method for protecting content stored on a recordable CD, comprising:
a) reading the values of the disc ID and the Lead-in start time from said recordable CD;
b) generating an encryption key from said read values;
c) encrypting the content that should be stored on said CD using said encryption key and writing the encrypted content to the recordable CD;
d) whenever attempting to read the content of a CD carrying out the following steps:
d.1) reading the values of the disc ID and the Lead-in start time from said CD;
d.2) generating a decryption key from said read values; and
d.3) decrypting the content of said CD with said decryption key.

7. A method according to claim 6, wherein the same key is used for carrying out the encryption and the decryption of the protected content.

8. a method for protecting the content stored on a recordable CD, comprising:
a) recording on said CD a first session including one or more Tracks, each of which includes unique and/or nonstandard data structures;
b) recording on said CD the protected contented in a concealed form and an authentication module capable of determining the existence or non-existence of said unique and/or nonstandard data structures and capable of accessing the concealed content and reveal its content; and
c) activating said authentication module whenever attempting to access said CD, and if said unique and/or nonstandard data structures are found on said CD allowing said concealed content to be revealed and accessed.

9. A method according to claim 8, wherein the unique and/or nonstandard data structures comprise Rom Sync Shifts.

10. A method according to claim 8, wherein the unique and/or nonstandard data structures comprise Digital Silence.

11. A method according to claim 8, wherein the unique and/or nonstandard data structures comprise Link Blocks.

12. A method according to claim 8, wherein said unique and/or nonstandard data structures comprise Predetermined Rom Skew values.

13. A method according to claim 8, further comprising storing unique serial numbers in predetermined locations within the one or more Tracks, comprising:
a) one or more unique copy-seal serial numbers, which are stored in predetermined locations in the User Data of predetermined data frames within said Tracks; and
b) one or more unique copy-authentication serial numbers which are stored in predetermined locations in the Sub Channels of predetermined data frames within said Tracks.

14. A method according to claim 13, wherein the copy-seal and/or copy-authentication serial numbers are used to identify the original copy of the protected content which was used for the copying of a pirate copy.

15. A method according to claim 13, wherein the bits of the copy-authentication serial numbers are stored in the Copy Permit/Prohibit bit of the Q Sub-Channel of a sequence of predetermined data frames within the one or more Tracks.

16. A method for preventing the illegal copying of a copy protected content by a computerized system comprising: setting a flag to a logical ON state whenever an active process attempts to read data from said content, where said flag is generally in a logical OFF state and it is associated with said process; and checking the status of the flag associated with a process attempting to output data and preventing said data output if said flag is in the logical ON state.

17. A copy protected recordable CD, comprising:
a) a pre-burned session comprising one or more Tracks;
b) unique and/or nonstandard data structures in the User Data field and/or the Sub Channels of predetermined frames within said Track, where only portion of said data structures can be copied by conventional recorders;
c) one or more additional sessions comprising content encrypted by an encryption key which is generated from values obtained from said data structures; and
d) a software module capable of identifying the existence or non-existence of said data structures in the first session of a CD and determining if said CD is an original or a copy, whenever an original CD determination is obtained said software module generates a decryption key from values obtained from said data structures and decrypts the content of said additional sessions.

18. A copy protected recordable CD according to claim 17, wherein the one or more Tracks are recorded in different Subcode Formats.

19. A copy protected recordable CD according to claim 17, wherein the unique and/or nonstandard data structures comprise Rom Sync Shifts.

20. A copy protected recordable CD according to claim 17, wherein the unique and/or nonstandard data structures comprise Digital Silence.

21. A copy protected recordable CD according to claim 17, wherein the unique and/or nonstandard data structures comprise Link Blocks.

22. A copy protected recordable CD according to claim 17, wherein said unique and/or nonstandard data structures comprise Predetermined Rom Skew values.

23. A copy protected recordable CD according to claim 17, further comprising storing unique serial numbers in predetermined locations within the one or more Tracks, comprising:
a) one or more unique copy-seal serial numbers, which are stored in predetermined locations in the User Data of predetermined data frames within said Tracks; and
b) one or more unique copy-authentication serial numbers which are stored in predetermined locations in the Sub Channels of predetermined data frames within said Tracks.

24. A copy protected recordable CD according to claim 23, wherein the copy-seal and/or copy-authentication serial numbers are used to identify the original copy of the protected content which was used for the copying of a pirate copy.

25. A copy protected recordable CD according to claim 23, wherein the bits of the copy-authentication serial numbers are stored in the Copy Permit/Prohibit bit of the Q Sub-Channel of a sequence of predetermined data frames within the one or more Tracks.

26. A copy protected recordable CD according to claim 17 comprising a pre-burned session comprising one or more Tracks including predetermined locations within the one or more Tracks, comprising:
a) one or more unique copy-seal serial numbers, which are stored in predetermined locations in the User Data of predetermined data frames within said Tracks; and
b) one or more unique copy-authentication serial numbers which are stored in predetermined locations in the Sub Channels of predetermined data frames within said Tracks.

27. a method for producing a copy protected storage medium, comprising:
a) writing data into a first set of a predetermined number of consecutive sectors having consecutive addresses; and
b) following said first set, writing different data into a second set of the same predetermined number of consecutive sectors having the same consecutive addresses as said first set,
such that any attempt to copy said medium results in copying only one of said sets.

28. a method for producing a copy protected storage medium, comprising:
a) designating a sector address as a starting location for writing authenticating data sectors;
b) following said starting location writing data into a first set of a predetermined number of consecutive sectors having consecutive addresses;
c) following said first set, writing different data into a second set of the same predetermined number of consecutive sectors having the same consecutive addresses as said first set; and
d) following said second set, designating a sector as an ending location and setting the address of said sector to the consecutive address following said first set,
such that any attempt to copy said medium results in copying said starting location sector, one of said sets, and said ending location sector.

29. a method according to claim 28, further comprising authenticating a storage medium by performing the following steps:
a) reading the data of the first set of sectors and producing an identifier for each read sector;
b) reading the ending location sector;
c) reading the sectors preceding said ending location sector in a descending order, producing an identifier for each read sector, and comparing said identifier to the identifier previously produced for the corresponding sector in said first set;
d) indicating that the storage medium is original whenever it is determined that the identifiers which were produced for corresponding sectors mismatch, and if it is determined that said identifiers match indicating said medium being a copy.
